(19) United States
(12) Patent Application Publication
(10) Pub. No.: US 2014/0177883 A1
(43) Pub. Date: Jun. 26, 2014

(54) Total Angle 360-Angled Loudspeaker Cabinet Enclosure Designing Technology

(71) Applicants: Shakeel Naksh Bandi P Syed, Phoolsha Mohalla (IN); Narayana Venkata Chalapathy Krishnappa, Gulper Kolar (IN); Shrinivaas Noah, Karnataka (IN)

(72) Inventors: Shakeel Naksh Bandi P Syed, Phoolsha Mohalla (IN); Narayana Venkata Chalapathy Krishnappa, Gulper Kolar (IN); Shrinivaas Noah, Karnataka (IN)

(21) Appl. No.: 14/234,693

(22) PCT Filed: Jul. 23, 2012
(86) PCT No.: PCT/IB2012/053734

§ 371 Date: Jan. 24, 2014

(30) Foreign Application Priority Data
Jul. 25, 2011 (IN) 2544/CHE/2011

(51) Int. Cl. H04R 5/02

(52) U.S. Cl. CPC H04R 5/02
USPC 381/307

(57) ABSTRACT

The present invention provides angled loudspeaker cabinet enclosures utilized for sound reproduction. The invention mainly comprises a setup of loudspeaker cabinet enclosures which include front, centre and rear loudspeaker cabinet enclosure in various embodiments wherein the font surfaces of the speaker units are inclined to wherein the sound waves emanating from the speaker units directly reach the listener present at the direction of inclination of the front surface to provide clear, immersive and 360 degree angle coverage to the listener irrespective of the location of the listener with respect to the sound source by distributing sound waves uniformly across the listening area.

### FIELD OF THE INVENTION

The invention generally relates to angled loudspeaker cabinet enclosures utilized for sound reproduction wherein the sound waves dispersed from various speakers unit directly reach the listener present in the direction of inclination of the front surface of the speakers which provides clear, immersive and 360 degree angle coverage to the listener irrespective of the location of the listener with respect to the sound source by distributing sound waves uniformly across the listening area.

### BACKGROUND OF THE INVENTION

Surround sound is a technique for enriching the sound reproduction quality of an audio source with additional audio channels from speakers that surround the listener (surround channels), providing sound from a 360° radius in the horizontal plane (2D) as opposed to ‘screen channels’ (centre, front left, and front right) originating only from the listener's forward arc. Surround sound is characterized by a listener location or sweet spot where the audio effects work best, and presents a fixed or forward perspective of the sound field to the listener at this location. The technique enhances the perception of sound spatialization by exploiting sound localization; a listener's ability to identify the location or origin of a detected sound in direction and distance. Typically this is achieved by surround sound systems that include multiple discrete audio channels routed to an array of loudspeakers. The speakers in surround sound systems separate an audio signal into multiple speakers wherein each speaker disperses sound in the direction perpendicular to the plane formed by the front face of the speaker. Such conventional speakers have sound dispersion axis of all the speakers units in a particular fixed axis, for example perpendicular to the plane of the speaker unit. Speakers perform best when the listener's head is directly in front of the speaker and at the same height as the drivers. The sound response where the driver is pointing directly at the listener is called the on-axis response. When the listener moves off-axis (to either side or a different height), the speaker will not sound as loud and sharp. Hence, in order to experience immersive surround sound effects, a listener has to sit at a location in the dispersion axis inside the listening area and the listener sitting at the location outside the dispersion axis of the speakers is unable to experience the sound effects with same quality. This problem is experienced even more when the listening area is a large area such as a large auditorium or a theatre. In order to overcome the problem, the loudspeakers cabinet enclosures should be designed to embody the room with equal timbre for all horizontal and vertical angles of coverage. In order to provide a uniform dispersion of sound effects throughout the listening area, adjustable speakers are provided wherein depending upon the location of the listener, the direction of sound dispersion axis can be adjusted by rotating the face of the speaker towards the listener.

U.S. Pat. No. 7,570,778 entitled ‘Angled Speaker Assembly’ discloses a speaker frame that can be rotated to adjust the direction and/or angle of sound dispersion axis of a speaker mounted therein as per the location of the listener. One embodiment of the invention includes a recessed speaker frame with an angled flange mounted on an angled ridge. The angled flange rides on the angled ridge to cause the angle of the speaker frame to change, relative to a mounting surface, within a range of angles. The speaker frame assembly is capable of being adjusted to any angle, relative to the third plane of the baffle, between a minimum angle and a maximum angle by rotating the speaker frame assembly about the first axis. This invention though provides a solution for adjusting the speaker as per the location of the user in a particular direction but in case the listeners are sitting at a location not covered by the speakers coverage area, or in case the listening area is a large enclosed room for example a large auditorium or a theatre, it becomes practically difficult to adjust the direction of each speaker according to the location of the listener.

Hence what is needed is a speaker system for use in small as well as large listening areas wherein the user can enjoy the same sound effects from any location irrespective of the direction/location of the speakers.

### SUMMARY OF THE INVENTION

The present invention provides angled loudspeaker cabinet enclosures utilized for sound reproduction wherein the sound waves dispersed from various speakers unit directly reach the listener present in the direction of inclination of the front surface of the speakers which provides clear, immersive and 360 degree angle coverage to the listener irrespective of the location of the listener with respect to the sound source by distributing sound waves uniformly across the listening area.

In one embodiment, a 360 degree angled loudspeaker system is disclosed which comprises at least one front left loudspeaker cabinet enclosure, at least one center loudspeaker cabinet enclosure and at least one rear loudspeaker cabinet enclosure to cover the entire listening area with sound effects. In one embodiment, the front loudspeaker cabinet enclosure comprises at least one top speaker unit disposed at the top of the front loudspeaker cabinet enclosure. The top speaker unit has a sound source mounted on its front surface from inside to reproduce sound signals received from a suitable sound source wherein the front surface of the top speaker unit is inclined at a pre determined angle (∠a) relative to a horizontal axis. The front loudspeaker cabinet enclosure includes at least one middle speaker unit disposed under the top speaker unit. The front surface of middle speaker unit is inclined parallel to the horizontal axis (x-x′) to disperse sound waves emanating from the sound source directly reach the listener in a direction perpendicular to the front surface. The front loudspeaker cabinet enclosure also includes at least one bottom speaker unit disposed under the middle speaker unit. The front surface of the bottom speaker unit is inclined at a predetermined angle (∠b) relative to a horizontal axis (x-x′) wherein the angle (∠b) is symmetrically opposite to the angle (∠b). A baffle unit is positioned under the middle speaker unit.

The 360 degree angled loudspeaker system includes at least one centre loudspeaker cabinet enclosure for mounting at the centre of at least two front loudspeaker cabinet enclosures. The centre loudspeaker cabinet enclosure comprises at least one left speaker unit, at least one middle speaker unit and at least one bottom speaker unit. Each speaker unit has a sound source mounted on front surface from inside to reproduce sound signals received from a suitable sound source. The front surface of the left speaker unit is inclined forward at a pre determined angle (∠c) relative to a horizontal axis. The front surface of the left speaker unit is inclined parallel to the horizontal axis (x-x′) to disperse sound waves emanating from the sound source in direction perpendicular to the front surface. At least one right speaker unit is coupled to the centre speaker unit wherein the front surface of the right speaker unit is inclined forward at a pre determined angle (∠d) relative to a horizontal axis. The angle (∠d) is symmetrically opposite to the angle (∠c) wherein the front surface configured to disperse sound waves emanating from the sound source in a direction opposite to that of the left speaker unit.

The 360 degree angled loudspeaker system includes a rear loudspeaker cabinet enclosure mounted at the rear of the listener to disperse sound from the rear. The rear loudspeaker cabinet enclosure further comprises at least one left speaker unit, at least centre speaker unit and at least one right speaker unit. The front surface of the left speaker unit is inclined backwards at a predetermined angle (∠e) relative to a horizontal axis. The front surface is further inclined downwards at a predetermined angle (∠f) relative to a vertical axis. The front surface is diagonally inclined downwards at bottom left corner inclined at a angle (∠g) relative to vertical axis (y-y′) wherein the front surface is configured to disperse sound waves emanating from the sound source in the direction of inclination of the front surface. At least one centre speaker unit is coupled to the left speaker unit wherein the centre speaker unit is having a sound source mounted on front surface from inside to reproduce sound signals received from a suitable sound source. The front surface of the centre speaker unit is inclined downwards at a predetermined angle (∠h) relative to a vertical axis (y-y′) to disperse sound waves in the direction of inclination of the front surface. The right speaker unit is coupled to the centre speaker unit wherein the front surface of the right speaker unit is inclined backwards at a predetermined angle (∠i) relative to a horizontal axis and the front surface is further inclined downward at a predetermined angle (∠j) relative to a vertical axis. The front surface is diagonally inclined downwards at bottom right corner inclined at an angle (∠k) relative to vertical axis (y-y′) wherein the front surface is configured to disperse sound waves emanating from the sound source in the direction of inclination of the front surface. All the speaker units in the 360 degree angled loudspeaker system have a flange around the external edges of the front surface of the speaker units wherein the flange extends at least 2 to 4 inches from the front surface whereby directing the sound waves to the direction of inclination of respective front surfaces. The sound waves emanating from the sound sources directly reach the listener present at the direction of inclination of the front surface to provide clear, immersive and 360 degree angle coverage to the listener irrespective of the location of the listener with respect to the sound source by distributing sound waves uniformly across the listening area.

In another embodiment, a 360 degree multi speaker sound system for use in large listening areas is disclosed. The 360 degree multi speaker sound system comprises at least one front multi speaker cabinet enclosure, at least one centre multi speaker cabinet enclosure and at least one rear multi speaker cabinet enclosure. The front multi speaker cabinet enclosure is mounted at the front side, facing the audience in a large listening area. The front multi speaker cabinet enclosure further comprises at least one speaker unit further comprising at least one left speaker unit wherein the front surface of the left speaker unit is inclined at a predetermined angle (∠a) relative to a horizontal axis (x-x′). At least one right speaker unit is coupled to the left speaker unit wherein the front surface of the right speaker unit is inclined parallel to the horizontal axis (x-x′) to disperse sound waves in direction perpendicular to the front surface.

The 360 degree multi speaker sound system further includes a centre multi speaker cabinet enclosure for mounting at the centre of at least two front multi speaker cabinet enclosures. The centre multi speaker cabinet enclosure further comprises at least one top speaker unit further comprising at least one left speaker unit having a sound source mounted on front surface from inside to reproduce sound signals received from a suitable sound source. At least one centre speaker unit is coupled to the left speaker unit and at least one right speaker unit is coupled to the centre speaker unit wherein the front surfaces of the left speaker unit, centre speaker unit and right speaker unit are inclined parallel to the horizontal axis (x-x′) to disperse sound waves in a direction perpendicular to the front surface. The centre multi speaker cabinet enclosure further comprises at least one middle speaker unit further comprising at least one left speaker unit wherein the front surface of the left speaker unit is diagonally inclined downwards at bottom right corner at a angle (∠b) relative to vertical axis (y-y′). At least one centre speaker unit is coupled to the left speaker unit wherein the front surface of the centre speaker unit is inclined downwards at a predetermined angle (∠c) relative to a vertical axis (y-y′) wherein the front surface is configured to disperse sound waves emanating from the sound source in the direction of inclination of front surface. At least one right speaker unit is coupled to the centre speaker unit wherein the front surface of the right speaker unit is diagonally inclined downwards at bottom left corner inclined at a angle (∠d) relative to vertical axis (y-y′) wherein the front surface is configured to disperse sound waves emanating from the sound source in the direction of inclination of front surface. At least one bottom speaker unit is coupled to the top speaker unit. The bottom speaker unit further comprises at least one left speaker unit wherein the front surface of the bottom speaker unit is diagonally inclined downwards at bottom right corner inclined at an angle (∠e) relative to vertical axis (y-y′). At least one centre speaker unit is coupled to the left speaker unit wherein the front surface of the centre speaker unit is inclined downwards at a predetermined angle (∠f) relative to a vertical axis (y-y′) wherein the front surface is configured to disperse sound waves emanating from the sound source in the direction of inclination of the front surface. At least one right speaker unit is coupled to the centre speaker unit wherein the front surface of the right speaker unit is diagonally inclined downwards at bottom left corner inclined at an angle (∠g) relative to vertical axis (y-y′). The front surface is configured to disperse sound waves emanating from the sound source in the direction of inclination of the front surface.

The rear multi speaker cabinet enclosure mounted at the rear of the audience in a large listening area further comprises at least one top speaker unit. The top speaker unit further comprises at least one top left speaker unit wherein the front surface of the top left speaker unit is inclined at an angle (∠h) relative to a horizontal axis (x-x′) and is inclined at an angle (∠i) relative to a vertical axis (y-y′). The front surface is further diagonally inclined inward at top left corner inclined at an angle (∠j) relative to vertical axis (y-y′) wherein the front surface is configured to disperse sound waves emanating from the sound source in the direction of inclination. At least one top centre speaker unit is coupled to the top left speaker unit wherein the front surface of the top centre speaker unit is inclined inward at an angle (∠k) relative to vertical axis (y-y′) wherein the front surface is configured to disperse sound waves emanating from the sound source in the direction of inclination of the front surface. At least one top right speaker unit is coupled to the top centre speaker unit wherein the front surface of the top right speaker unit is inclined at an angle (∠l) relative to a horizontal axis (x-x′) and is inclined at a angle (∠m) relative to a vertical axis (y-y′). The front surface is further diagonally inclined inward at top right corner inclined at a angle (∠n) relative to vertical axis (y-y′) wherein the front surface configured to disperse sound waves emanating from the sound source in the direction of inclination of the front surface. At least one bottom speaker unit is disposed below top speaker unit. The bottom speaker unit further comprises at least one bottom left speaker unit is coupled to the bottom speaker unit wherein the angle of inclination of the front surface of the bottom left speaker unit is vertically opposite to the angle of inclination of the front surface of the top left speaker unit. At least one bottom centre speaker unit is coupled to the bottom left speaker unit wherein the angle of inclination of the front surface of the bottom centre speaker unit is vertically opposite to the angle of inclination of the front surface of the top centre speaker unit. At least one bottom right speaker unit is coupled to the bottom speaker unit wherein the angle of inclination of the front surface of the bottom right speaker unit is vertically opposite to the angle of inclination of the front surface of the top right speaker unit. The sound waves emanating from the sound sources directly reach the listener present at the direction of inclination of the front surface to provide clear, immersive and 360 degree angle coverage to the listener irrespective of the location of the listener with respect to the sound source by distributing sound waves uniformly across the listening area.

### BRIEF DESCRIPTION OF DRAWINGS

FIG. 1 shows the front left loudspeaker cabinet enclosure and the front right loudspeaker cabinet enclosure in accordance with one embodiment of the invention.

FIG. 1b shows the front left loudspeaker cabinet enclosure and the front right loudspeaker cabinet enclosure without flange in accordance with one embodiment of the invention.

FIG. 2a to 2c illustrate the orthogonal top view of the top speaker unit, middle speaker unit and the bottom speaker unit in accordance with one embodiment of the invention.

FIG. 3a shows the prospective view of the center loudspeaker cabinet enclosure in accordance with one embodiment of the invention.

FIG. 3b shows the orthogonal top view of the center loudspeaker cabinet enclosure in accordance with one embodiment of the invention.

FIG. 4a shows the prospective view of the rear surround loudspeaker cabinet enclosure without external flanges in accordance with one embodiment of the invention.

FIG. 4b shows the prospective view of the rear surround loudspeaker cabinet enclosure with external flanges in accordance with one embodiment of the invention.

FIG. 4c shows the orthogonal top view of the rear surround loudspeaker cabinet enclosure in accordance with one embodiment of the invention.

FIG. 4d shows the orthogonal side view of the left speaker unit of the rear surround loudspeaker cabinet enclosure in accordance with one embodiment of the invention.

FIG. 4e shows the orthogonal side view of the centre speaker unit of the rear surround loudspeaker cabinet enclosure in accordance with one embodiment of the invention.

FIG. 4f shows the orthogonal side view of the right speaker unit of the rear surround loudspeaker cabinet enclosure in accordance with one embodiment of the invention.

FIG. 5 shows the virtual centre and the area coverage of the sound using front loudspeaker cabinet enclosure.

FIG. 6 illustrates the sound emanating from the top speaker units of the front loudspeaker cabinet enclosures and the listening area covered.

FIG. 7 illustrates the sound emanating from the bottom speaker units of the front left loudspeaker cabinet enclosure and front right loudspeaker cabinet enclosure and the listening area covered.

FIG. 8 illustrates the sound emanating from the left speaker unit of the centre loudspeaker cabinet enclosure and the listening area covered.

FIG. 9 illustrates the sound emanating from the right speaker unit of the centre loudspeaker cabinet enclosure and the listening area covered.

FIG. 10 illustrates the sound emanating from the middle speaker unit of the centre loudspeaker cabinet enclosure and the listening area covered.

FIG. 11 illustrates the sound emanating from the rear left loudspeaker cabinet enclosure and the listening area covered.

FIG. 12 illustrates the sound emanating from the rear right loudspeaker cabinet enclosure and the listening area covered.

FIG. 13 illustrates the coverage area of the sound emanating from the 360 degree angled loudspeaker cabinet enclosure system.

FIG. 14a illustrates the front loudspeaker cabinet enclosure of 360 degree multi speaker sound system for use in large listening areas according to one embodiment of the invention.

FIG. 14b illustrates the orthogonal top view of the front loudspeaker cabinet enclosure of 360 degree multi speaker sound system for use in large listening areas according to one embodiment of the invention.

FIG. 15 illustrates the area covered by the right speaker units of front left multi speaker cabinet enclosure and front right multi speaker cabinet enclosure of 360 degree multi speaker sound system.

FIG. 16 illustrates the area covered by the left speaker units of both front multi speaker cabinet enclosures of 360 degree multi speaker sound system.

FIG. 17 illustrates a centre multi speaker cabinet enclosure for use in large listening areas according to one embodiment of the invention.

FIG. 17a illustrates the orthogonal side view of the left speaker unit according to one embodiment of the invention.

FIG. 17b illustrates the orthogonal side view of the centre speaker unit according to one embodiment of the invention.

FIG. 17c illustrates the orthogonal side view of the right speaker unit according to one embodiment of the invention.

FIG. 17d illustrates the orthogonal side view of the left speaker unit according to one embodiment of the invention.

FIG. 18 illustrates the sound emanating from the centre multi speaker cabinet enclosure inside a large listening area according to one embodiment of the invention.

FIG. 19 illustrates the coverage of sound waves emanating from the top speaker unit of the centre multi speaker cabinet enclosure placed inside a large listening area.

FIG. 20 illustrates the coverage of sound waves emanating from the middle speaker unit of the centre multi speaker cabinet enclosure placed inside a large listening area.

FIG. 21 illustrates the direction of sound waves emanating from the bottom speaker unit of the centre multi speaker cabinet enclosure placed inside a large listening area.

FIG. 22 illustrates a rear multi speaker cabinet enclosure of 360 degree multi speaker sound system for use in large listening areas, according to one embodiment of the invention.

FIG. 22a illustrates the orthogonal top view of the top speaker unit according to one embodiment of the invention.

FIG. 22b illustrates the orthogonal side view of the top left speaker unit according to one embodiment of the invention.

FIG. 22c illustrates the orthogonal side view of the top centre speaker unit according to one embodiment of the invention.

FIG. 22d illustrates the orthogonal side view of the top right speaker unit according to one embodiment of the invention.

FIG. 23 illustrates the coverage of sound waves emanating from rear right multi speaker cabinet enclosure of 360 degree multi speaker sound system mounted in a large listening area.

FIG. 24 illustrates the coverage of sound waves emanating from rear left multi speaker cabinet enclosure of 360 degree multi speaker sound system mounted in a large listening area.

FIG. 25a illustrates 5.1 channel multidirectional speaker cabinet enclosure according to one embodiment of the invention.

FIG. 25b illustrates the orthogonal top view of the 5.1 channel multidirectional speaker cabinet enclosure),

FIG. 26 illustrates the coverage area of the 5.1 channel multidirectional speaker cabinet enclosure with virtual sound effect.

FIG. 27a illustrates an alternate embodiment of the 5.1 channel multidirectional speaker cabinet enclosure according to one embodiment of the invention.

FIG. 27b illustrates the orthogonal top view of the 5.1 channel multidirectional speaker cabinet enclosure according to one embodiment of the invention.

FIG. 28 illustrates the coverage area of the alternate embodiment of the 5.1 channel multidirectional speaker cabinet enclosure with reversed polarities of the speakers in the speaker dividing system.

FIG. 29a illustrates the 1.1 multi directional loudspeaker cabinet enclosure according to one embodiment of the invention.

FIG. 30 illustrates the coverage area of the 1.1 channel multidirectional speaker cabinet enclosure receiving stereo channel input from an audio source.

FIG. 31 illustrates the coverage area with virtual sound effect, of the 1.1 channel multidirectional speaker cabinet enclosure receiving 3 dimensional digital surround sound N 360 from an audio source with reversed polarities of the speakers in the speaker dividing system.

FIG. 32 illustrates the coverage area with virtual sound effect, of the 1.1 channel multidirectional speaker cabinet enclosure receiving 3 dimensional digital surround sound N 360 from an audio source.

FIG. 33 illustrates the coverage area of the 1.1 channel multidirectional speaker cabinet enclosure receiving stereo channel input from an audio source.

### DETAILED DESCRIPTION OF THE INVENTION

The present invention provides angled loudspeaker cabinet enclosures utilized for sound reproduction. The invention mainly comprises a setup of loudspeaker cabinet enclosures which include front, centre and rear loudspeaker cabinet enclosure in various embodiments wherein the font surfaces of the speaker units are inclined to wherein the sound waves emanating from the speaker units directly reach the listener present at the direction of inclination of the front surface to provide clear, immersive and 360 degree angle coverage to the listener irrespective of the location of the listener with respect to the sound source by distributing sound waves uniformly across the listening area.

The loudspeaker cabinet enclosures design and shape create remarkably high quality sound effects and provide 360 listening coverage without changing the position of the loudspeaker cabinet enclosure. The system of technology is user friendly as the cabinet design can be easily used with many existing audio/music applications without any modifications.

In the following description, certain terminology is used to describe certain features of one or more embodiments of the invention. For instance, the term ‘speaker’ is used to refer to any type of sound generating device such as audio electronic equipment, loudspeakers, audio speakers, woofers, subwoofers, audio mixers and tweeters etc.

Generally, 5.1 channel surround sound audio system provides a very precise surround sound from 5 speakers and a subwoofer. Front left, centre and right channels deliver dialogue and on-screen sounds, while left and right surround channels provide the surround effect while a sub-woofer reproduces very low frequency sound i.e. bass. All six channels are recorded separately for superior channel separation, which ultimately leads to greater steering of sound effects around the room. The present invention consists of front left, front right, centre (mainly for speech) and left rear/right rear (for special sound effects) loudspeaker units, combining to provide 360 degree surround sound effects. The design of the speakers reproduces the sound splitting effects providing an immersive and real sound experience to the listener irrespective of his/her position inside the listening area.

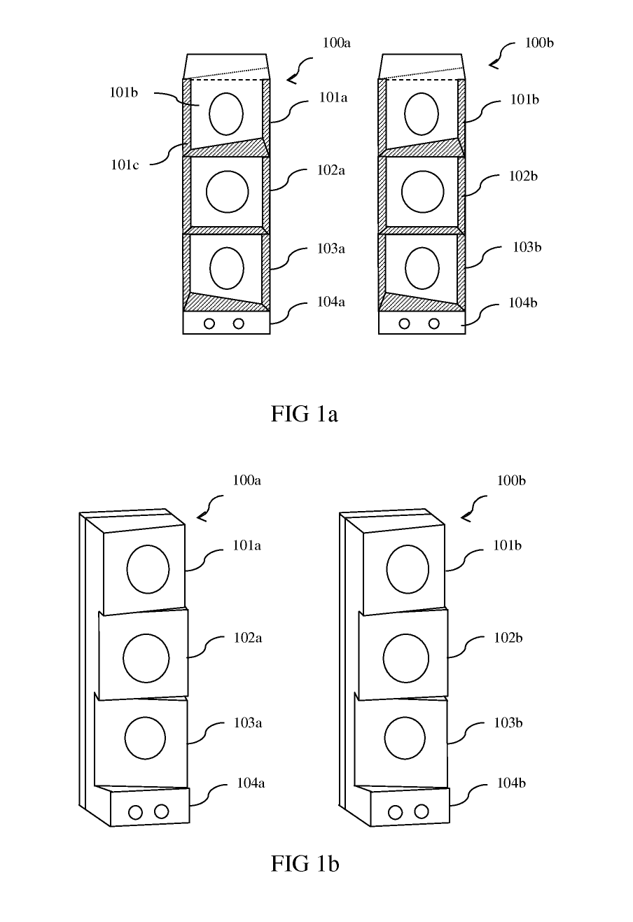

FIG. 1 shows the front left loudspeaker cabinet enclosure and the front right loudspeaker cabinet enclosure in accordance with one embodiment of the invention. In one embodiment, the front left loudspeaker cabinet enclosure (100a) comprises a top speaker unit (101a), a centre speaker unit (102a) disposed under the top speaker unit (101a), a bottom speaker unit (103a) disposed under the centre speaker unit (102a) and baffle unit (104a) disposed under the bottom speaker unit (103). Each speaker unit has a suitable sound source mounted on their front surface (101b) from inside to reproduce sound signals received from a suitable sound source. All the speaker units have a flange (101c) around the external edges of the front surface of the speaker units wherein the flange (101c) extends at least 2 to 4 inches from the front surface (101b) whereby directing the sound waves to the direction of inclination of respective front surfaces (101b). In one embodiment, the vertical orientation of both, the front left loudspeaker cabinet enclosure (100a) and front right loudspeaker cabinet enclosure (100b) is identical and at least two such loudspeaker cabinet enclosure (100a) are mounted preferably on either side of the viewing screen such as a television unit, or a screen etc to provide 360 degree immersive sound effects.

FIG. 1b shows the front left loudspeaker cabinet enclosure and the front right loudspeaker cabinet enclosure without flange in accordance with one embodiment of the invention.

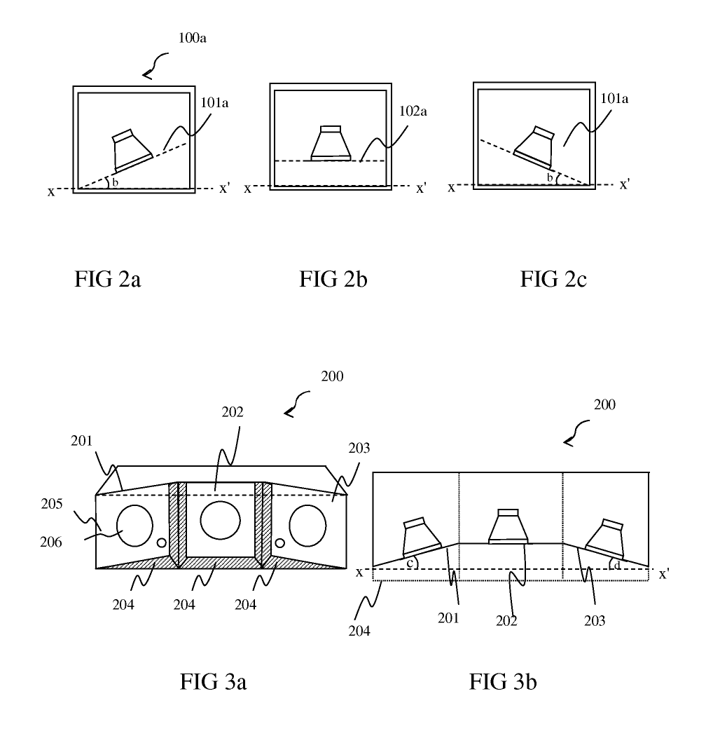

FIGS. 2a to 2c illustrate the orthogonal top view of the top speaker unit, middle speaker unit and the bottom speaker unit in accordance with one embodiment of the invention. As illustrated in the figure, the front surface of the top speaker unit (101a) of the left front loudspeaker cabinet enclosure (100a) is inclined backwards at a pre determined angle (∠a) relative to a horizontal axis (x-x′) wherein the front surface is configured to disperse sound waves emanating from the sound source in the direction of inclination to cover listeners at the left hand side of the listening area while facing front loudspeaker cabinet enclosure (100a). In one embodiment, the angle (∠a) ranges from 20 deg to 45 deg to radiate sound in the direction of inclination of the front surface.

In one embodiment, the front surface of the middle speaker unit (102a) is inclined parallel to the horizontal axis (x-x′) to disperse sound waves emanating from the sound source in a direction perpendicular to the front surface to cover listeners at the centre of the listening area while facing front loudspeaker cabinet enclosure (100a).

In one embodiment, the front surface of the bottom speaker unit (103a) is inclined at a predetermined angle (∠b) relative to a horizontal axis (x-x′) wherein the angle (∠b) is symmetrically opposite to the angle (∠a). The inclined surface is configured to disperse sound waves emanating from the sound source in a direction opposite to that of the top speaker unit (101a) to cover listeners present at the right hand side of the listening area while facing front loudspeaker cabinet enclosure (100a). In one embodiment, the second angle (∠a) ranges from at least 20 deg to 45 deg to radiate sound in the direction of inclination of the front surface. The sound waves emanating from the sound sources directly reach the listener present at the direction of inclination of the front surface to provide clear, immersive and 360 degree angle coverage to the listener irrespective of the location of the listener with respect to the sound source by distributing sound waves uniformly across the listening area.

The baffle unit (104a) contains the vented cabinet measuring at least 2 to 4 inches in height. The baffle is the important part of the loudspeaker cabinet enclosure design. The purpose of the baffle is two-fold: to uphold the natural resonant frequency of the cabinet enclosure and to prevent the sound from the front and the back of the waves from meeting and causing noise interference. The obvious manner in which to keep the front and rear waves from ever meeting is to extend the baffle. This baffle blocks the interference and creates a better sound. A baffle unit (104a) is a small pipe disposed inside the cabinet that allows air to move freely in and out of the cabinet and also prevents the cabinet from getting air tight. The design provides two functionalities to the loudspeakers cabinet enclosure; first, the rear sound wave reinforces the front sound wave and increases the overall speaker efficiency. Secondly, by carefully calculating the diameter and length of the port, the natural resonance of the cabinet enclosure design can be tuned. The orientation of the front right loudspeaker cabinet enclosure is opposite to that of the front left loudspeaker cabinet enclosure.

FIG. 3a shows the prospective view of the center loudspeaker cabinet enclosure in accordance with one embodiment of the invention. In one embodiment, the center loudspeaker cabinet enclosure (200) comprises a left speaker unit (201) disposed at the extreme left, a centre speaker unit (202) coupled to the left speaker unit (201) and a right speaker unit (203) coupled to the centre speaker unit (202). Each speaker unit has a suitable sound source (205) mounted on their front surface (205) from inside to reproduce sound signals received from a suitable sound source. All the speaker units have a flange (204) around the external edges of the front surface of the speaker units wherein the flange (204) extends at least 2 to 4 inches from their front surfaces whereby directing the sound waves to the direction of inclination of respective front surfaces. In this arrangement, the speaker mounted within the flange would have a sound emanating axis substantially perpendicular to the front surface.

FIG. 3b shows the orthogonal top view of the center loudspeaker cabinet enclosure in accordance with one embodiment of the invention. As illustrated in the figure, the front surface of the left speaker unit (201) is inclined forward at a pre determined angle (∠c) relative to a horizontal axis (x-x′). The front surface is configured to disperse sound waves emanating from the sound source in the direction of inclination which covers the listeners present at the left hand side of the listening area while facing centre loudspeaker cabinet enclosure (200). In one embodiment, the angle (∠c) of the front surface of the left speaker unit (201) ranges from at least 5 degree to 30 degree. The front surface of the centre speaker unit (202) is inclined parallel to the horizontal axis (x-x′) to disperse sound waves emanating from the sound source in direction perpendicular to the front surface to cover the listeners present at the centre of the listening area while facing center loudspeaker cabinet enclosure (200).

The front surface of right speaker unit (203) is inclined forward at a pre determined angle (∠d) relative to a horizontal axis (x-x) wherein the angle (∠d) is symmetrically opposite to the angle (∠c). The front surface of right speaker unit (203) is configured to disperse sound waves emanating from the sound source in a direction opposite to that of the left speaker unit (201) to cover the listeners present at the right hand side of the listening area while facing centre loudspeaker cabinet enclosure (200). In preferred embodiments, the angle (∠d) ranges from at least 5 degree to 30 degree to disperse the sound waves in a direction opposite to that of the left speaker unit (201) to cover listeners present on the opposite side.

The sound waves emanating from the sound sources directly reach the listener present at the direction of inclination of the front surface to provide clear, immersive and 360 degree angle coverage to the listener irrespective of the location of the listener with respect to the sound source by distributing sound waves uniformly across the listening area.

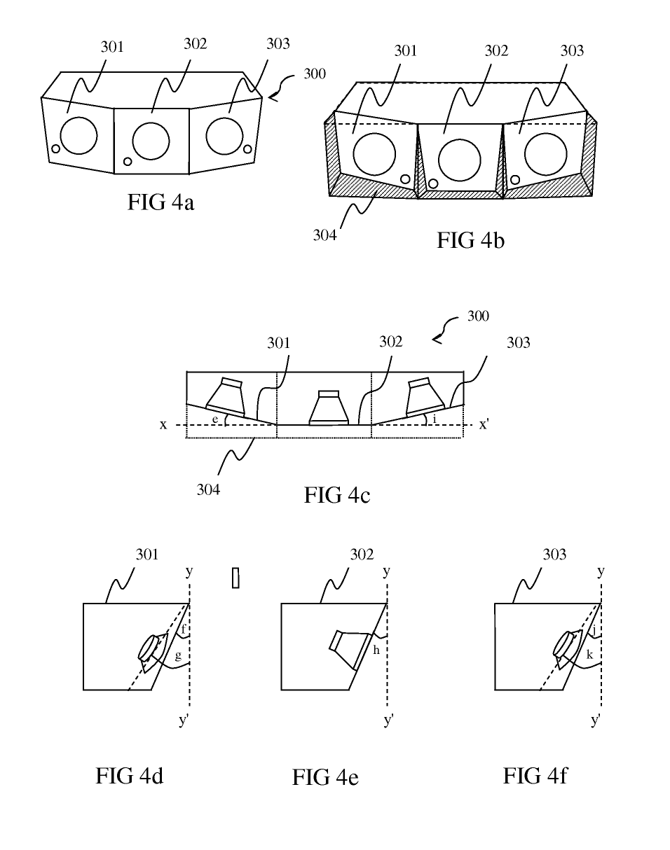

FIG. 4a shows the prospective view of the rear surround loudspeaker cabinet enclosure without external flanges in accordance with one embodiment of the invention. The rear surround loudspeaker cabinet enclosure (300) is preferably mounted at the rear of the listener to disperse sound from the rear of the listening area. In most preferred embodiments, the rear surround loudspeaker cabinet enclosure (300) comprises at least one left speaker unit (301) disposed at the extreme left, at least one centre speaker unit (302) coupled to the left speaker unit (301) and at least one right speaker unit (303) coupled to the centre speaker unit (302). Each speaker unit has a suitable sound source (205) mounted on their front surface (205) from inside to reproduce sound signals received from a suitable sound source.

FIG. 4b shows the prospective view of the rear surround loudspeaker cabinet enclosure with external flanges in accordance with one embodiment of the invention. As shown in the figure, all the speaker units have a flange (304) around the external edges of the front surface of the speaker units wherein the flange (304) extends at least 2 to 4 inches from their front surfaces whereby directing the sound waves to the direction of inclination of respective front surfaces by having a sound emanating axis substantially perpendicular to the front surface.

FIG. 4c shows the orthogonal top view of the rear surround loudspeaker cabinet enclosure in accordance with one embodiment of the invention. As illustrated in the figure, the front surface of the left speaker unit (301) is inclined backwards at a predetermined angle (∠e) relative to a horizontal axis (x-x′). In most preferred embodiment, the angle (∠e) ranges from at least 5 degree to 60 degree. The front surface of the right speaker unit (303) is inclined backwards at a predetermined angle (∠i) relative to a horizontal axis (x-x′). In most preferred embodiment, the angle (∠i) ranges from at least 5 degree to 30 degree.

FIG. 4d shows the orthogonal side view of the left speaker unit of the rear surround loudspeaker cabinet enclosure in accordance with one embodiment of the invention. In one embodiment, the front surfaces of the left speaker unit (301) is inclined downwards at a predetermined angle (∠f) relative to a vertical axis (y-y′). In most preferred embodiment, the angle (∠f) ranges from at least 5 degree to 60 degree. Furthermore, the diagonal from the top right corner to the bottom left corner of the front surface of the left speaker unit (301) is further inclined downwards at a angle (∠g) relative to vertical axis (y-y′) wherein the front surface is configured to disperse sound waves emanating from the sound source in the direction of inclination to cover listeners at the left hand side of the listening area while facing the front loudspeaker cabinet enclosure (100). In most preferred embodiment, the angle (∠g) ranges from at least 10 degree to 60 degree.

FIG. 4e shows the orthogonal side view of the centre speaker unit of the rear surround loudspeaker cabinet enclosure in accordance with one embodiment of the invention. As illustrated in the figure, the front surface of the centre speaker unit (302) is inclined downwards at a predetermined angle (∠h) relative to a vertical axis (y-y′) to disperse sound waves in the direction of inclination to cover listeners at the centre of the listening area while facing front loudspeaker cabinet enclosure (100).

FIG. 4f shows the orthogonal side view of the right speaker unit of the rear surround loudspeaker cabinet enclosure in accordance with one embodiment of the invention. As illustrated in the figure the front surfaces of the right speaker unit (303) is inclined downwards at a predetermined angle (∠j) relative to a vertical axis (y-y′). In most preferred embodiment, the angle (∠j) ranges from at least 5 degree to 60 degree. Furthermore, the diagonal from the top left corner to the bottom right corner of the front surface of the right speaker unit (303) is further inclined downwards at an angle (∠k) relative to vertical axis (y-y′) wherein the front surface is configured to disperse sound waves emanating from the sound source in the direction of inclination to cover listeners at the right hand side of the listening area while facing the front loudspeaker cabinet enclosure (100). In most preferred embodiment, the angle (∠k) ranges from at least 10 degree to 60 degree. The rear surround loudspeaker cabinet enclosure is preferably mounted in a direction opposite to that of the front loudspeakers and at the rear of the listener inside a room or a hall. The rear surround loudspeaker cabinet enclosure serves as rear surround. The sound waves emanating from the sound sources directly reach the listener present at the direction of inclination of the front surface to provide clear, immersive and 360 degree angle coverage to the listener irrespective of the location of the listener with respect to the sound source by distributing sound waves uniformly across the listening area.

FIG. 5 shows the virtual centre and the area coverage of the sound using front loudspeaker cabinet enclosure. The two front loudspeaker cabinet enclosures (100a, 100b) placed on two opposite side provides a 3 dimensional listening experience by introducing a virtual centre (100c) as illustrated in the figure.

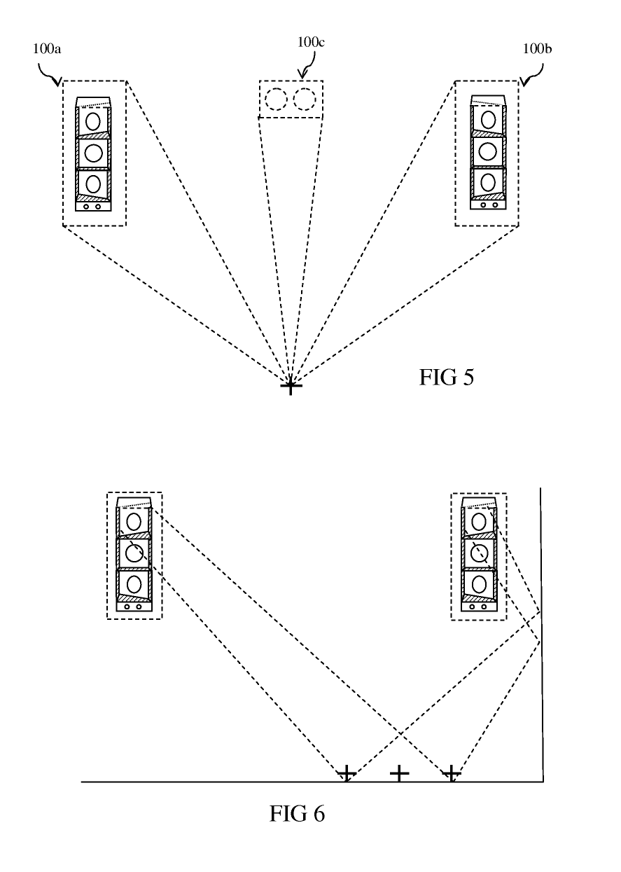

FIG. 6 illustrates the sound emanating from the top speaker units of the front loudspeaker cabinet enclosures and the listening area covered. The figure illustrates the sound emanating from the top speaker units (101a and 101b) of the left loudspeaker cabinet enclosure (100a) and right loudspeaker cabinet enclosures (100b).

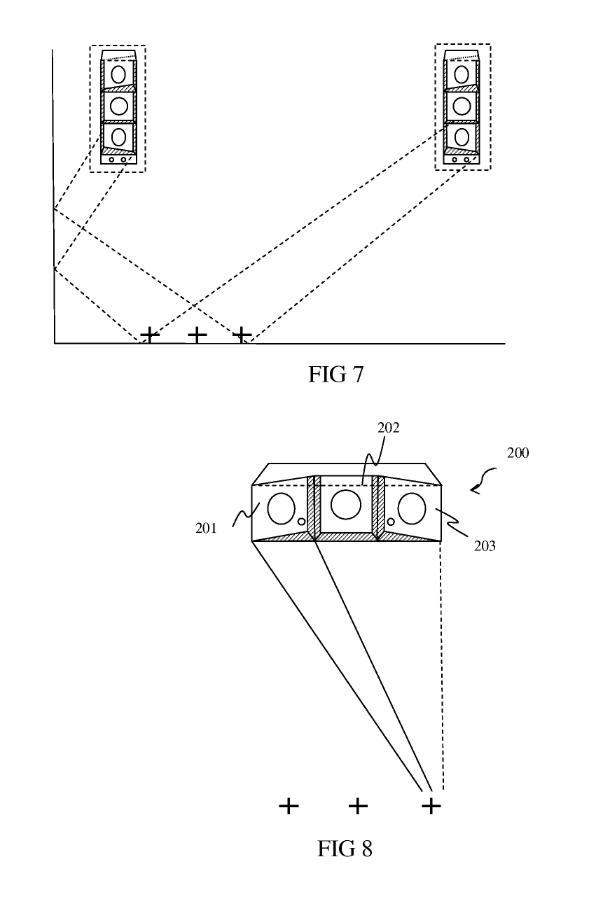

FIG. 7 illustrates the sound emanating from the bottom speaker units of the front left loudspeaker cabinet enclosure and front right loudspeaker cabinet enclosure and the listening area covered. The figure illustrates the sound emanating from the bottom speaker units (103a and 103b) of the left loudspeaker cabinet enclosure (100a) and right loudspeaker cabinet enclosures (100b). The area covered is also illustrated.

FIG. 8 illustrates the sound emanating from the left speaker unit of the centre loudspeaker cabinet enclosure and the listening area covered. As shown in the figure, the left speaker unit (201) of the centre loudspeaker cabinet enclosure (200) covers the listener sitting at the right hand side of the listening area as the front surface of the speaker inside the left speaker unit (201) is angled towards the right hand side.

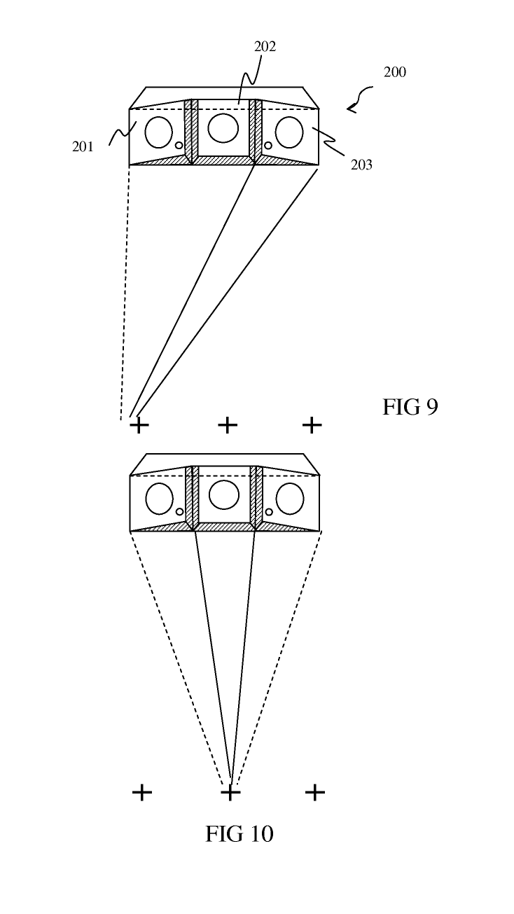

FIG. 9 illustrates the sound emanating from the right speaker unit of the centre loudspeaker cabinet enclosure and the listening area covered. The right speaker unit (203) of the centre loudspeaker cabinet enclosure (200) covers the listener present at the left hand side of the listening area as the front surface of the speaker inside the right speaker unit (203) is inclined towards the left hand side.

FIG. 10 illustrates the sound emanating from the middle speaker unit of the centre loudspeaker cabinet enclosure and the listening area covered. The middle speaker unit (202) of the centre loudspeaker cabinet enclosure (200) covers the listener sitting at the centre of the listening area as the front surface of the speaker inside the centre speaker unit (202) projects perpendicular to the centre loudspeaker cabinet enclosure (200) to cover listeners sitting in the line of sound projection.

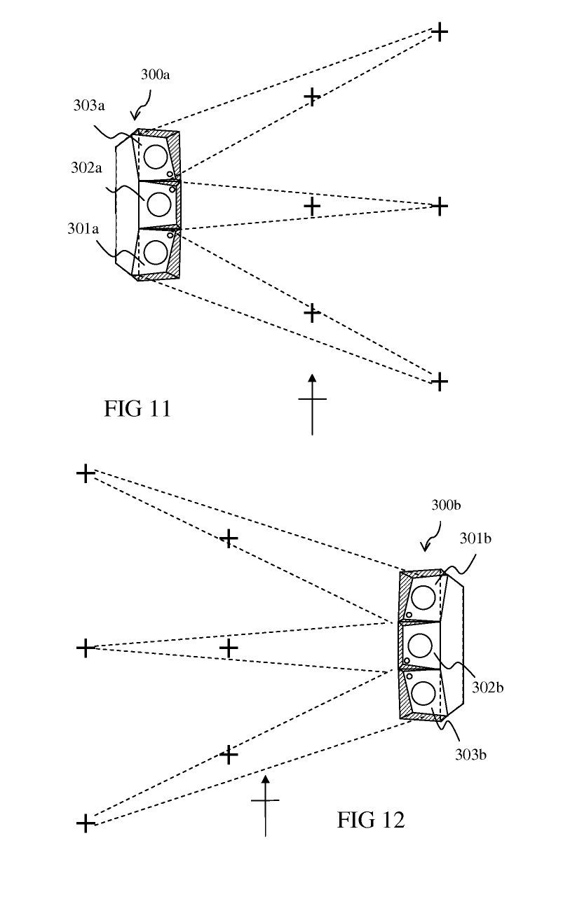

FIG. 11 illustrates the sound emanating from the rear left loudspeaker cabinet enclosure and the listening area covered. While configuring the speaker system in a listening area, at least two rear loudspeaker cabinet enclosures may be arranged at the rear of the listeners facing front side to provide complete 360 listening angle coverage. As illustrated, the rear left loudspeaker cabinet enclosure (300a) covers a listener sitting at the back side, middle and the front of the listening area due to the angled front surfaces of the speakers unit in the rear loudspeaker cabinet enclosure (300a).

FIG. 12 illustrates the sound emanating from the rear right loudspeaker cabinet enclosure and the listening area covered. As illustrated, the rear right loudspeaker cabinet enclosure (300b) mounted at the rear right hand side of the listener, covers the back side, middle and the front of the listening area due to the angled front surfaces of the speakers in the rear loudspeaker cabinet enclosure (300b). The total area covered by both, the rear left loudspeaker cabinet enclosure (300a) and the rear right loudspeaker cabinet enclosure (300a) includes all the listeners sitting at the back side, middle and the front of the listening area.

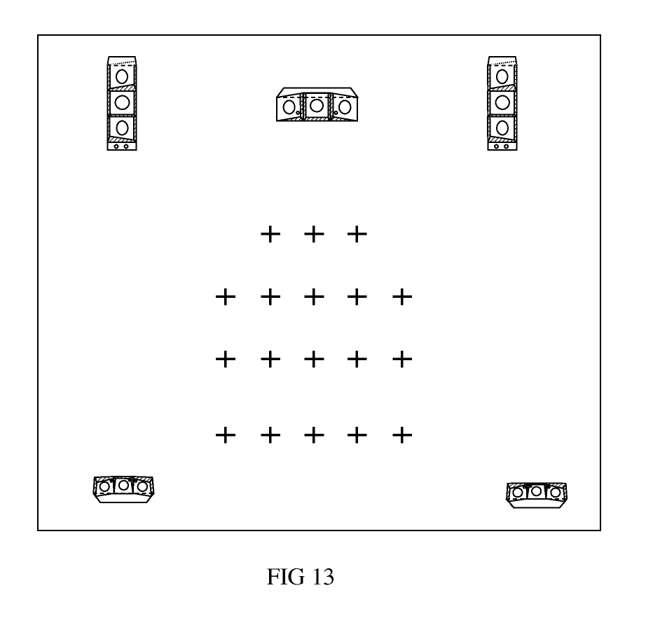

FIG. 13 illustrates the coverage area of the sound emanating from the 360 degree angled loudspeaker cabinet enclosure system. All the speakers in the 360-angle loudspeaker cabinet enclosure system, when used in combination, produce splitting sound effects with 360 degrees angular coverage inside a listening area wherein each listener inside the listening area can listen to the sound with same quality and splitting effects irrespective of his/her location inside the listening area. The system provides an equal distribution of sound at each point and each listener can experience the same three dimensional sound effects at any point inside the enclosed area.

### 360 Degree Multi Speaker Sound System

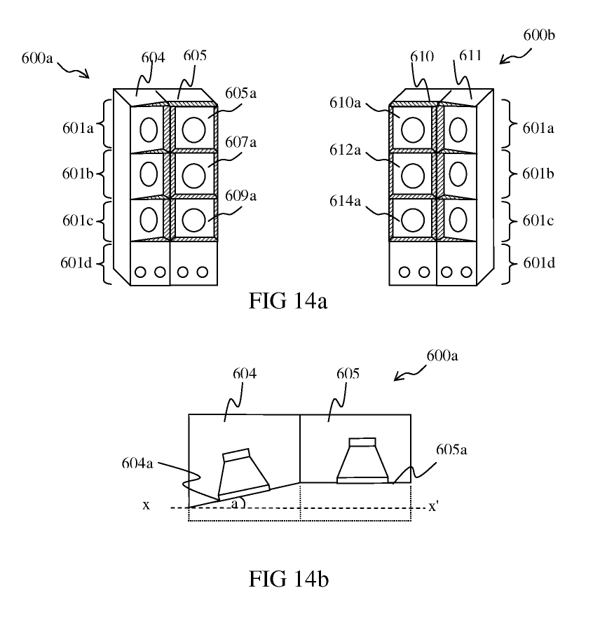

FIG. 14a illustrates the front loudspeaker cabinet enclosure of 360 degree multi speaker sound system for use in large listening areas according to one embodiment of the invention. In this embodiment, a multi speaker sound system is disclosed which can be used in large listening areas such as a movie theatre, a big hall or an auditorium etc. The 360 degree multi speaker loudspeaker cabinet enclosure (600) comprises at least one front left multi speaker cabinet enclosure (600a) and at least one front right multi speaker cabinet enclosure (600b) mounted at the front side, facing the audience in a large listening area. The front left multi speaker cabinet enclosure (600a) further comprises at least one speaker unit (601a) further comprising at least one left speaker unit (604) having a sound source mounted on its front surface from inside to reproduce sound signals received from a suitable sound source. In this embodiment, at least one right speaker unit (605) is coupled to the left speaker unit (604). The right speaker unit (605) has a sound source mounted on its front surface from inside to reproduce sound signals received from a suitable sound source. The inclination of the various speaker units in two front multi speaker cabinet enclosures (600a and 600b) are symmetrically opposite to each other. In various embodiments there may be more than one speaker units such as 601a, 601b or 601c etc disposed one above the other as illustrated in the exemplary embodiment in the figure. Depending upon the area of the listening area, the total number of such speaker units may be increased or decreased. A baffle unit is also disposed at the bottom of the front multi speaker cabinet enclosure (600).

FIG. 14b illustrates the orthogonal top view of the front loudspeaker cabinet enclosure of 360 degree multi speaker sound system for use in large listening areas according to one embodiment of the invention. As illustrated in the figure, wherein the front surface (604a) of each left speaker unit (604) is inclined at a predetermined angle (∠a) relative to a horizontal axis (x-x′). The front surface (604a) of each left speaker unit (604) is configured to disperse sound waves emanating from the sound source in the direction of inclination to cover audience present near the dispersion axis of the front surface (604a) while facing front multi speaker cabinet enclosure (600a). The front surface (605a) of each right speaker unit (605) is inclined parallel to the horizontal axis (x-x′) to disperse sound waves in a direction perpendicular to the front surface (605a) to cover audience present at the centre of the listening area while facing front multi speaker cabinet enclosure (600).

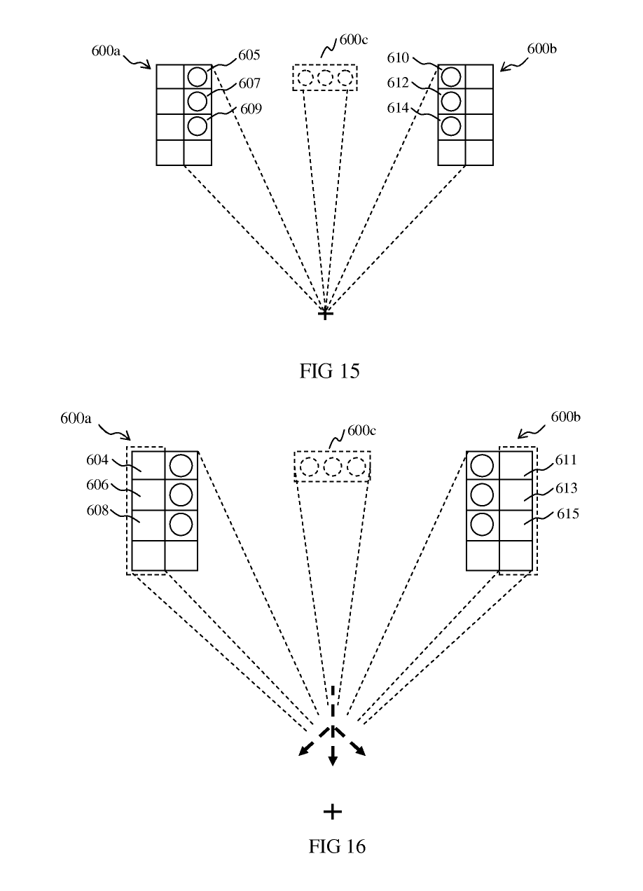

FIG. 15 illustrates the area covered by the right speaker units of front left multi speaker cabinet enclosure and front right multi speaker cabinet enclosure of 360 degree multi speaker sound system. Since the front surfaces (605a, 607a and 609a) of each speaker unit (605, 607 and 609) in front left multi speaker cabinet enclosure (600a) and front surface (610a, 612a, 614a) of each speaker units (610, 612 and 614) in front right multi speaker cabinet enclosure (600b), are flat and inclined parallel to the horizontal axis (x-x′), the sound waves emanating from right speaker unit (605, 607 and 609) and left speaker unit (610, 612 and 614) are directly received by the listeners present at the center of the listening area as shown in the figure.

FIG. 16 illustrates the area covered by the left speaker units of both front multi speaker cabinet enclosures of 360 degree multi speaker sound system. Since the front surfaces of each speaker unit (604, 606 and 608) in front left multi speaker cabinet enclosure (600a) and front surface of each speaker units (611, 613 and 615) in front right multi speaker cabinet enclosure (600b), are inclined at a predetermined angle relative to a horizontal axis (x-x′), the dispersion axis of the sound waves dispersed from the speaker unit (604, 606 and 608) and speaker unit (611, 613 and 615) is inclined to cover additional area as compared to conventional loudspeaker units present in the prior art. As illustrated in the figure, the area covered by the angled speakers on both, the front left multi speaker cabinet enclosure (600a) and the front right multi speaker cabinet enclosure (600b) is much wider as compared to the area covered by the flat speakers since the angled speakers in the system provide an additional coverage area to the listener. The two multi speaker cabinet enclosures (600a and 600b) also create a virtual centre (600c) to the audience present in the listening area. Hence the angled speakers in the front loudspeaker cabinet enclosures increase the total coverage area of the front speakers to a great extent and the sound waves directly reach the audience present in a much wider area. The angular design of the exterior speakers provides more area of coverage to the direct sound waves and provides 360 degree listening experience to the listener.

### Centre Multi Speaker Cabinet Enclosure

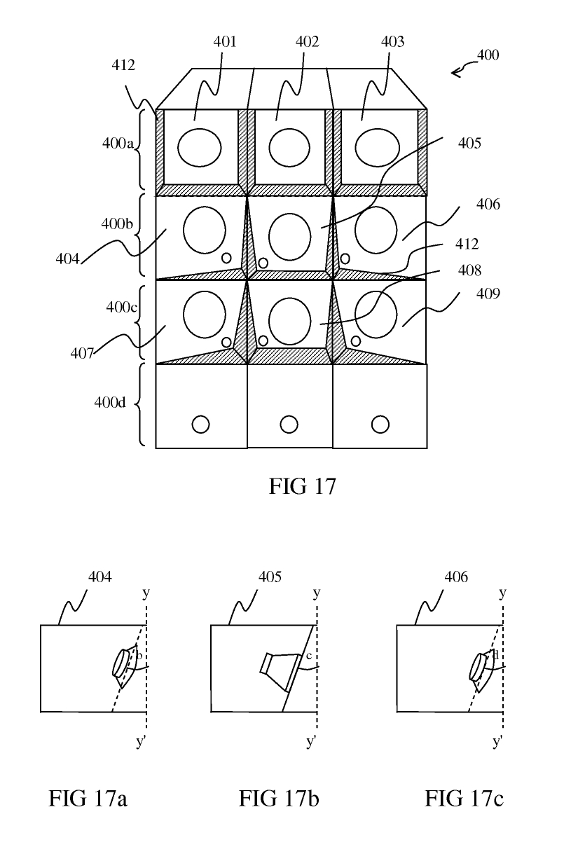

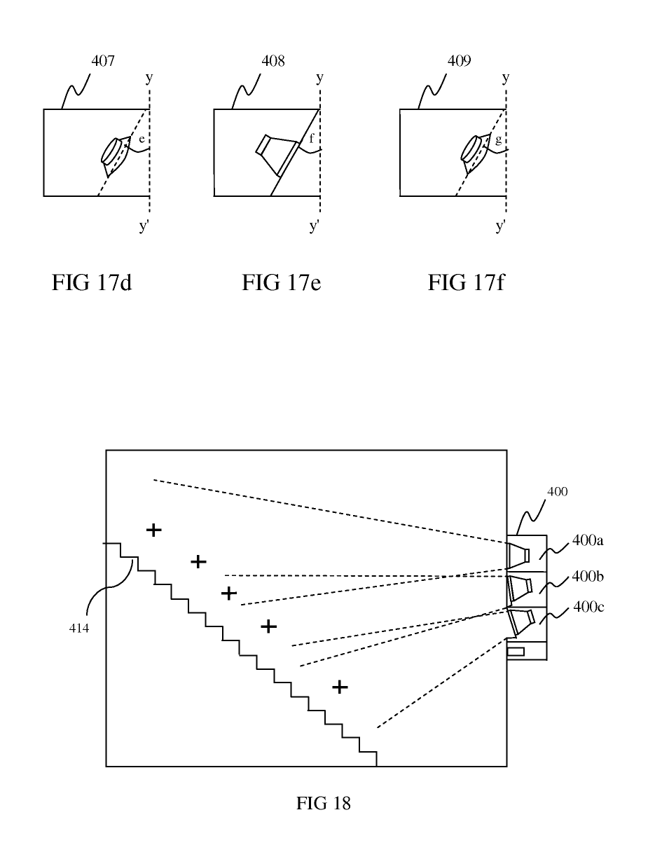

FIG. 17 illustrates a centre multi speaker cabinet enclosure for use in large listening areas according to one embodiment of the invention. In this embodiment, a 360 degree multi speaker cabinet enclosure (400) is illustrated which can be mounted at the centre of at least two front multi speaker cabinet enclosures (600a and 600b, FIG. 14a) in preferred embodiments to experience 360 degree surround sound effects. In one embodiment, the centre multi speaker cabinet enclosure (400) comprises at least one top speaker unit (400a) which further comprises at least one left speaker unit (401), at least one centre speaker unit (402) coupled to the left speaker unit (401) and at least one right speaker unit (403) coupled to the centre speaker unit (402). All the speaker units (410, 402 and 403) have a suitable sound source mounted on their front surfaces from inside to reproduce sound signals received from a suitable sound source. In one embodiment, the front surfaces of the left speaker unit (401), centre speaker unit (402) and right speaker unit (403) are inclined parallel to the horizontal axis (x-x′) to disperse sound waves in a direction perpendicular to the front surface to cover the listeners present at the centre of the back side of the listening area while facing front multi speaker cabinet enclosure (400).

In one embodiment, the centre multi speaker cabinet enclosure (400) further includes at least one middle speaker unit (400b) further comprising at least one left speaker unit (404) having a sound source mounted on front surface from inside to reproduce sound signals received from a suitable sound source. As shown in the FIG. 17a (orthogonal side view of the left speaker unit), the front surface is diagonally inclined downwards at bottom right corner at an angle (∠b) relative to vertical axis (y-y′) wherein the front surface is configured to disperse sound waves emanating from the sound source in the direction of inclination to cover listeners present at the left hand side of the middle of the listening area while facing front multi speaker cabinet enclosure (400). In one most preferred embodiment, the angle (∠b) ranges from 10 degree to 60 degree.

The middle speaker unit (400b) further includes at least one centre speaker unit (405) coupled to the left speaker unit (404) wherein the centre speaker unit (405) has a sound source mounted on front surface from inside to reproduce sound signals received from a suitable sound source. As shown in the FIG. 17b (orthogonal side view of the centre speaker unit), the front surface is inclined downwards at a predetermined angle (∠c) relative to a vertical axis (y-y′) wherein the front surface is configured to disperse sound waves emanating from the sound source in the direction of inclination to cover listeners present at the centre of the middle of the listening area while facing front multi speaker cabinet enclosure (400). In one most preferred embodiment, the angle (∠c) ranges from 5 degree to 60 degree.

The middle speaker unit (400b) also includes at least one right speaker unit (406) coupled to the centre speaker unit (405) wherein the right speaker unit (406) has a sound source mounted on front surface from inside to reproduce sound signals received from a suitable sound source. As shown in the FIG. 17c (orthogonal side view of the right speaker unit), the front surface is diagonally inclined downwards at bottom left corner inclined at an angle (∠d) relative to vertical axis (y-y′) wherein the front surface is configured to disperse sound waves emanating from the sound source in the direction of inclination to cover listeners present at the right hand side of the middle of the listening area while facing front multi speaker cabinet enclosure (400). In one most preferred embodiment, the angle (∠d) ranges from 10 degree to 60 degree.

In one embodiment, the centre multi speaker cabinet enclosure (400) further includes at least one bottom speaker unit (400c). In this embodiment, the construction and structure of bottom speaker unit (400c) is identical to the middle speaker unit (400b) wherein the front surfaces of various speaker units in bottom speaker unit (400c) are more inclined downwards as compared to the angle of inclination of front surface in middle speaker unit (400c). The bottom speaker unit (400c) further comprises at least one left speaker unit (407) having a sound source mounted on front surface from inside to reproduce sound signals received from a suitable sound source. As shown in the FIG. 17d (orthogonal side view of the left speaker unit), the front surface of left speaker unit (407) is diagonally inclined downwards at bottom right corner inclined at an angle (∠e) relative to vertical axis (y-y′) wherein the front surface is configured to disperse sound waves emanating from the sound source in the direction of inclination to cover listeners present at the left hand side of the front of the listening area while facing front multi speaker cabinet enclosure (400). In one most preferred embodiment, the angle (∠e) ranges from 5 degree to 70 degree.

The bottom speaker unit (400c) further includes at least one centre speaker unit (408) coupled to the left speaker unit (407) wherein the centre speaker unit (408) has a sound source mounted on front surface from inside to reproduce sound signals received from a suitable sound source. As shown in the FIG. 17e (orthogonal side view of the centre speaker unit), the front surface is inclined downwards at a predetermined angle (∠f) relative to a vertical axis (y-y′) wherein the front surface is configured to disperse sound waves emanating from the sound source in the direction of inclination to cover listeners present at the centre of the front side of the listening area while facing front multi speaker cabinet enclosure (400). In one most preferred embodiment, the angle (∠f) ranges from 5 degree to 70 degree.

The bottom speaker unit (400c) further includes at least one right speaker unit (409) coupled to the centre speaker unit (408) wherein the right speaker unit (409) has a sound source mounted on front surface from inside to reproduce sound signals received from a suitable sound source. As shown in the FIG. 17f (orthogonal side view of the right speaker unit), wherein the front surface is diagonally inclined downwards at bottom left corner inclined at an angle (∠g) relative to vertical axis (y-y′) wherein the front surface is configured to disperse sound waves emanating from the sound source in the direction of inclination to cover listeners present at the right hand side of the front side of the listening area while facing front multi speaker cabinet enclosure (400). In one most preferred embodiment, the angle (∠g) ranges from 10 degree to 70 degree. Under the bottom speaker unit (400c) a baffle unit (400d) is disposed.

All speaker units in the 360 degree multi speaker cabinet enclosure (400) have a flange (412) around the external edges of the front surfaces of each speaker unit wherein the flange (412) extends at least 2 inches to 4 inches from the front surface for directing the sound waves to the direction of inclination of respective front surfaces. The sound waves emanating from the sound sources directly reach the listener present at the direction of inclination of the front surface to provide clear, immersive and 360 degree angle coverage to the listener irrespective of the location of the listener with respect to the sound source by distributing sound waves uniformly across the listening area.

FIG. 18 illustrates the sound emanating from the centre multi speaker cabinet enclosure inside a large listening area according to one embodiment of the invention. The figure illustrates a large enclosed area such as an auditorium or a movie theatre with slanting sitting arrangement (414) as shown. At least one centre multi speaker cabinet enclosure (400) is mounted in between two front multi speaker cabinet enclosures on the front side of the listening area. The figure shows the direction of sound waves as being received by audience sitting at various levels inside the listening areas. Due to the pre determined angular inclination provided to various speaker units in the speaker units (400a, 400b and 400c), the sound waves directly reach the listeners sitting at various heights and locations inside a large listening areas which results in an immersive and clear sound listening experience with 360 degree angle coverage to the listener. As shown in the figure, the top speaker unit (400a) covers the listeners present at the centre of the backside of the listening area while facing front multi speaker cabinet enclosure (400). The middle speaker unit (400b) covers the listeners present at the centre of the middle of the listening area whereas the bottom speaker unit (400c) covers the listeners present at the centre of the front side of the listening area while facing front multi speaker cabinet enclosure (400). Hence the sound waves from angled speakers in centre multi speaker cabinet enclosure (400) directly reach the audience even in a large listening area which provides a complete listening experience with 360 immersive sound effects.

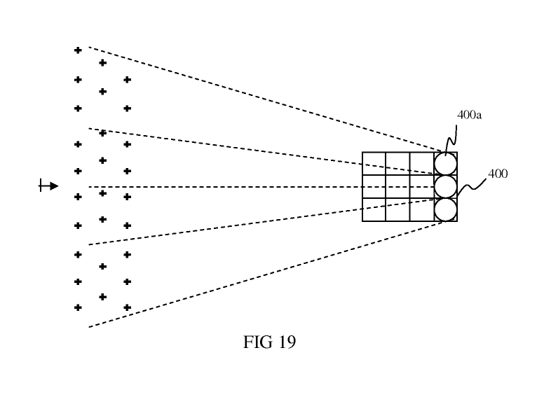

FIG. 19 illustrates the coverage of sound waves emanating from the top speaker unit of the centre multi speaker cabinet enclosure placed inside a large listening area. The top speaker unit (400a) of the main loud speaker cabinet enclosure (400) disperses sound waves in a direction perpendicular to front surface of the speakers units inside the top speaker unit (400a) which covers the listeners present at the centre of the backside of the listening area facing the centre multi speaker cabinet enclosure (400) as shown in the figure.

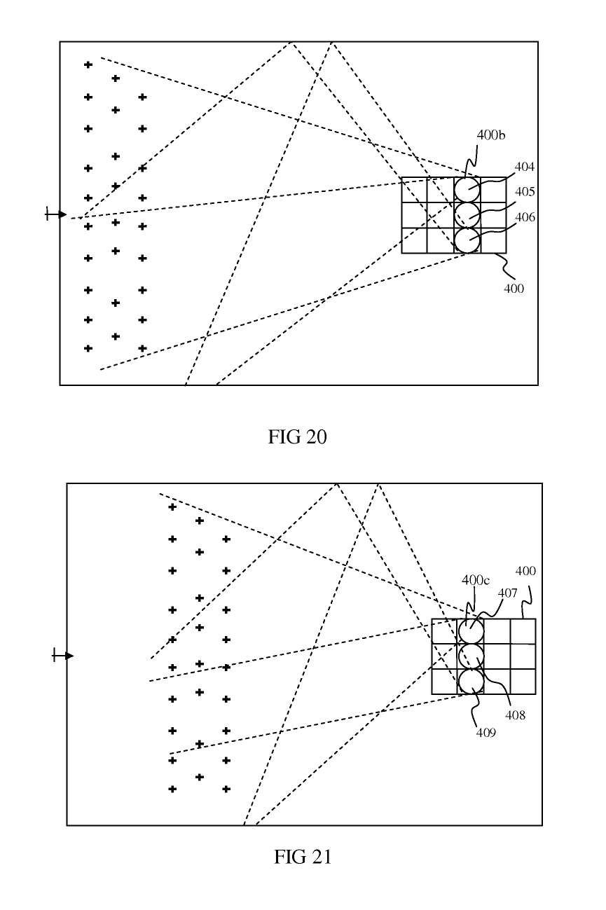

FIG. 20 illustrates the coverage of sound waves emanating from the middle speaker unit of the centre multi speaker cabinet enclosure placed inside a large listening area. The middle speaker unit (400b) of the centre multi speaker cabinet enclosure (400) disperses sound in three different directions. As shown in the figure, the left speaker unit (404) disperses sound downwards towards the left hand side of the middle of the listening area, the centre speaker unit (405) disperses sound downwards towards the centre of the middle of the listening area and the right speaker unit (406) disperses sound downwards towards the right hand side of the middle of the listening area. The directional sound dispersion enable sound to directly reach the listener at any location inside a large listening area which provides a clear, immersive and 360 degree angle coverage to the listener irrespective of the his/her location.

FIG. 21 illustrates the direction of sound waves emanating from the bottom speaker unit of the centre multi speaker cabinet enclosure placed inside a large listening area. The bottom speaker unit (400c) of the centre multi speaker cabinet enclosure (400) disperses sound in three different directions. As shown in the figure, the left speaker unit (407) disperses sound further downwards towards left hand side front side of the listening area, the centre speaker unit (408) disperses sound further downwards towards the centre of the front side of the listening area and the right speaker unit (409) disperses sound further downwards towards the right hand side of the front side of the listening area. Moreover, due to the further inclination provided to the speaker units in the bottom speaker unit (400c) as compared to the inclination provides in the middle speaker unit (400b), the sound waves directly reach the listeners sitting at the front of the large listening areas which provides clear, immersive and 360 degree angle coverage to the listener irrespective of the his/her location.

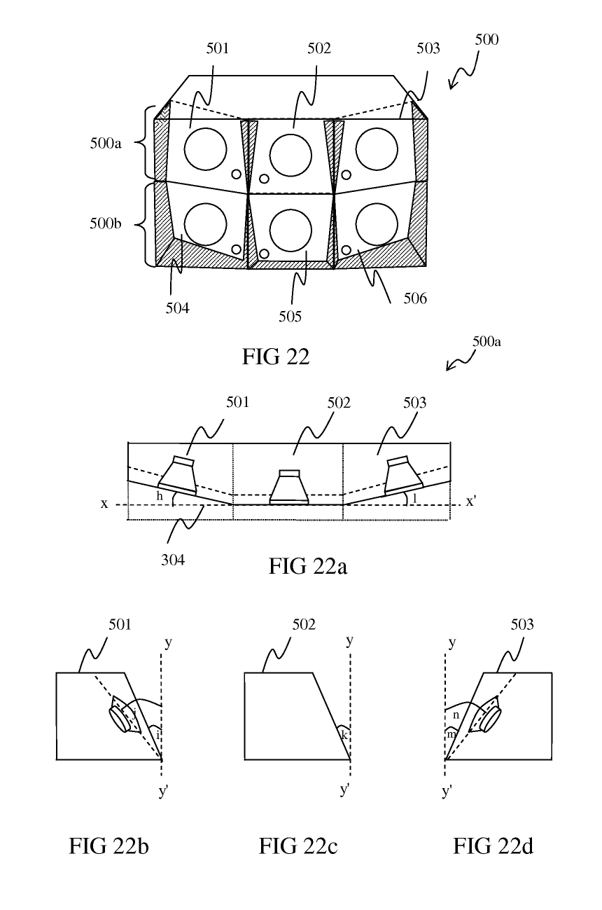

FIG. 22 illustrates a rear multi speaker cabinet enclosure of 360 degree multi speaker sound system for use in large listening areas, according to one embodiment of the invention. In one embodiment, a rear multi speaker cabinet enclosure (500) is provided for use in a large listening area such as a movie theatre, a big hall or an auditorium etc. In this embodiment, the rear loudspeaker cabinet enclosure (500) comprises at least one top speaker unit (500a) and at least one bottom speaker unit (500b) disposed below the top speaker unit (500a). The top speaker unit (500a) further comprises at least one top left speaker unit (501) having a sound source mounted on front surface from inside to reproduce sound signals received from a suitable sound source. As shown the FIG. 22a (orthogonal top view of the top speaker unit (500a)) the front surface of the top left speaker unit (501) is inclined at an angle (∠h) relative to a horizontal axis (x-x′). As shown in the FIG. 22b (orthogonal side view of the top left speaker unit), the front surface of the top left speaker unit (501) is further inclined at an angle (∠i) relative to a vertical axis (y-y′). The front surface is also diagonally inclined inward at top left corner at an angle (∠j) relative to a vertical axis (y-y′) wherein the front surface is configured to disperse sound waves emanating from the sound source in the direction of inclination. In most preferred embodiment, the angle (∠h) ranges from at least 5 degree to 30 degree, the angle (∠i) ranges from at least 5 degree to 60 degree and the angle (∠j) ranges from at least 10 degree to 60 degree.

The rear loudspeaker cabinet enclosure (500) further includes at least one top centre speaker unit (502) coupled to the top left speaker unit (501) wherein the top centre speaker unit (502) has a sound source mounted on front surface from inside to reproduce sound signals received from a suitable sound source. As shown in FIG. 22c (orthogonal side view of the top centre speaker unit), the front surface of the top centre speaker unit (502) is inclined inward at an angle (∠k) relative to vertical axis (y-y′). In most preferred embodiment, the angle (∠k) ranges from at least 5 degree to 70 degree.

The rear loudspeaker cabinet enclosure (500) further includes at least one top right speaker unit (503) coupled to the top centre speaker unit (502) wherein the top right speaker unit (503) has a sound source mounted on front surface from inside to reproduce sound signals received from a suitable sound source. As shown in FIG. 22a (orthogonal top view of the top speaker unit (500a)) the front surface of the top right speaker unit (503) is inclined at an angle (∠l) relative to a horizontal axis (x-x′). As shown in FIG. 22d (orthogonal side view of the top right speaker unit (503)) the front surface of the top right speaker unit (503) is inclined at an angle (∠m) relative to a vertical axis (y-y′) and the front surface is diagonally inclined inward at top right corner inclined at an angle (∠n) relative to a vertical axis (y-y′) wherein the front surface of the top right speaker unit (503) is configured to disperse sound waves emanating from the sound source in the direction of inclination. In most preferred embodiment, the angle (∠l) ranges from at least 5 degree to 30 degree, angle (∠m) ranges from at least 5 degree to 60 degree and angle (∠n) ranges from at least 10 degree to 60 degree.

The bottom speaker unit (500a) of the rear multi speaker cabinet enclosure (500) is disposed below the top speaker unit (500a) and further comprises at least one bottom left speaker unit (504) coupled to the bottom speaker unit (500b) wherein the angle of inclination of the front surface of the bottom left speaker unit (504) is vertically opposite to the angle of inclination of the front surface of the top left speaker unit (501). The bottom speaker unit (500a) further comprises at least one bottom centre speaker unit (505) coupled to the bottom left speaker unit (504) wherein the angle of inclination of the front surface of the bottom centre speaker unit (505) is vertically opposite to the angle of inclination of the front surface of the top centre speaker unit (502). The bottom speaker unit (500a) also includes at least one bottom right speaker unit (506) coupled to the bottom speaker unit (500b) wherein the angle of inclination of the front surface of the bottom right speaker unit (506) is vertically opposite to the angle of inclination of the front surface of the top right speaker unit (503).

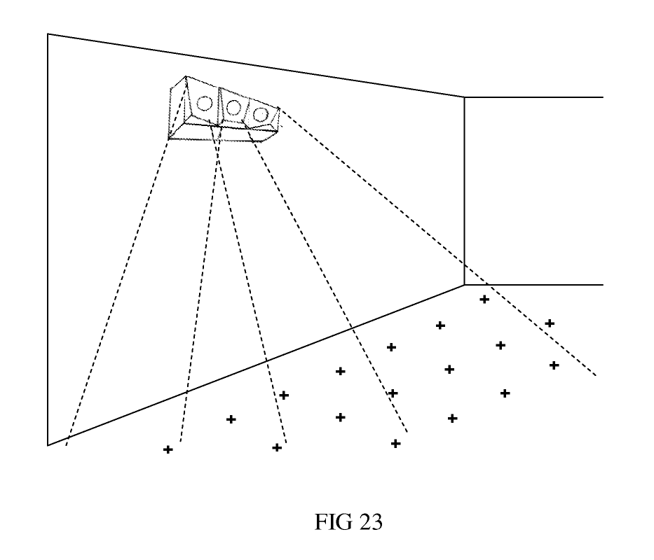

FIG. 23 illustrates the coverage of sound waves emanating from rear right multi speaker cabinet enclosure of 360 degree multi speaker sound system mounted in a large listening area. In large listening areas at least two rear multi speaker cabinet enclosures may be deployed for better listening experience and for providing 360 degree coverage to the listeners.

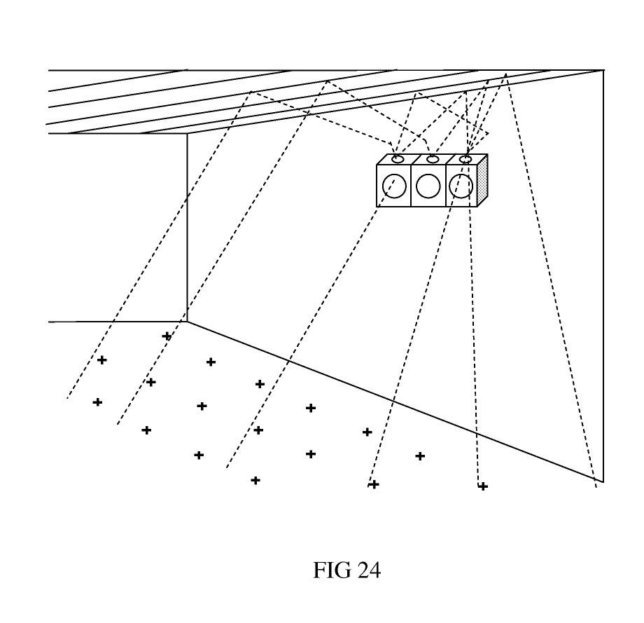

FIG. 24 illustrates the coverage of sound waves emanating from rear left multi speaker cabinet enclosure of 360 degree multi speaker sound system mounted in a large listening area. As illustrated in the figure, the sound dispersed from rear right rear right multi speaker cabinet enclosure of 360 degree multi speaker sound system.

### Multidirectional Speaker Cabinet Enclosure

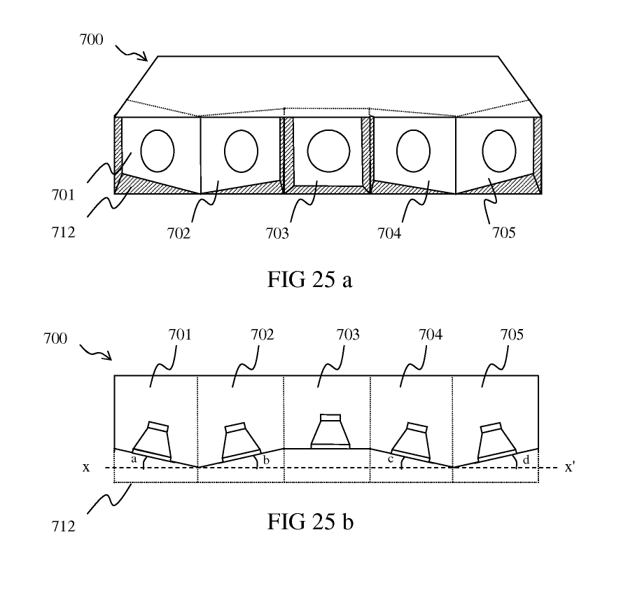

FIG. 25a illustrates 5.1 channel multidirectional speaker cabinet enclosure according to one embodiment of the invention. In this embodiment, a 5.1 channel multidirectional speaker cabinet enclosure (700) is disclosed which provides 360 degree angle coverage using one single speaker system in an enclosed listening area. In this embodiment, the multidirectional speaker cabinet enclosure (700) comprises at least one first speaker unit (701) having a sound source mounted on front surface from inside to reproduce sound signals received from a suitable sound source. As shown in the FIG. 25b (orthogonal top view of the 5.1 channel multidirectional speaker cabinet enclosure), the front surface of the first speaker unit (701) is inclined at an angle (∠a) relative to a horizontal axis (x-x′) wherein the front surface is configured to disperse sound waves emanating from the sound source in the direction of inclination. In one embodiment, the angle (∠a) ranges from at least 20 degree to 45 degree which provides a backward inclination to the front surface of first speaker unit (701) to disperse sound waves to the listeners sitting on the right hand side while facing the multidirectional speaker cabinet enclosure (700) inside a listening area.

The multidirectional speaker cabinet enclosure (700) includes at least one second speaker unit (702) coupled to the first speaker unit (701). The second speaker unit (702) includes a sound source mounted on front surface from inside to reproduce sound signals received from a suitable sound source. As shown in the FIG. 25b (orthogonal top view of the 5.1 channel multidirectional speaker cabinet enclosure), the front surface of the second speaker unit (702) is inclined at an angle (∠b) symmetrically opposite to the angle of inclination of the front surface of the first speaker unit (701). In one embodiment, the angle (∠b) of inclination ranges from at least 20 degree to 45 degree which provides an inclination to the front face of second speaker unit (702) in a direction opposite to that of the first speaker unit (701). In exemplary embodiment, the second speaker unit (702) is inclined forward towards the left hand side to disperse sound waves to the listeners sitting on the left hand side while facing the multidirectional speaker (700) inside a listening area.

The multidirectional speaker cabinet enclosure (700) also includes at least one third speaker unit (703) coupled to the second speaker unit (702) wherein the third speaker unit (703) has a sound source mounted on front surface from inside to reproduce sound signals received from a suitable sound source. As shown in the FIG. 25b (orthogonal top view of the 5.1 channel multidirectional speaker cabinet enclosure), the front surface is inclined parallel to a horizontal axis (x-x′) to disperse sound waves in a direction perpendicular to the flat surface to directly provide sound to the listener at the front side of the listening area.

In exemplary embodiment, a fourth speaker unit (704) is also coupled to the third speaker unit (703) wherein the front surface of the fourth speaker unit (704) is inclined at an angle symmetrically opposite to the angle (∠b) which provides an inclination to the front face of fourth speaker unit (704) towards the right hand side to disperse sound waves to the listeners sitting on the right hand side while facing the multidirectional speaker cabinet enclosure (700) inside a listening area.

In exemplary embodiment, another fifth speaker unit (705) is also coupled to the fourth speaker unit (704) wherein the front surface of the fifth speaker unit (705) is inclined at an angle (∠d) symmetrically opposite to the angle (∠c) which provides an inclination to the front face of fifth speaker unit (705) towards the left hand side to disperse sound waves to the listeners sitting on the left hand side while facing the multidirectional speaker cabinet enclosure (700) inside a listening area.

All the speaker units have a flange (712) around the external edges of the front surface of the speaker units wherein the flange (712) extends at least 2 inches to 4 inches from the front surface whereby directing the sound waves to the direction of inclination of respective front surfaces.

In this embodiment, only five speaker units are illustrated whereas any number of speaker units may be added to cover a larger listening area. This embodiment provides complete 360 degree listening coverage area using single 5.1 channel multidirectional speaker cabinet enclosure.

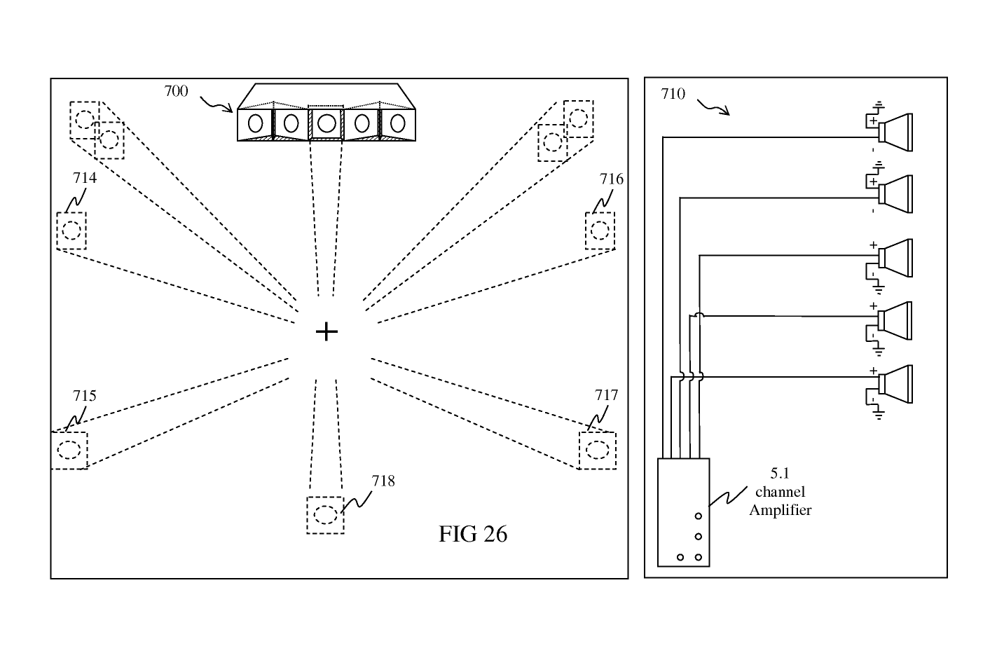

FIG. 26 illustrates the coverage area of the 5.1 channel multidirectional speaker cabinet enclosure with virtual sound effect. In this embodiment, angular inclination of various speaker units of a single 5.1 channel multidirectional speaker cabinet enclosure (700) provides 360 degree coverage inside an enclosed listening area as illustrated in the figure. Upon receiving input from a speaker dividing system (710) of a normal 5.1 channel AV receiver, the 5.1 channel multidirectional speaker cabinet enclosure (700) provides 360 degree angle coverage with virtual left angle coverage (714), virtual right angle coverage (716), virtual rear left angle coverage (715), virtual rear right angle coverage (714) and virtual centre coverage (718) as shown in the figure. In this embodiment, angular inclination of various speaker units of a single 5.1 channel multidirectional speaker cabinet enclosure (800) provides 360 degree angle coverage inside an enclosed listening area as illustrated in the figure.

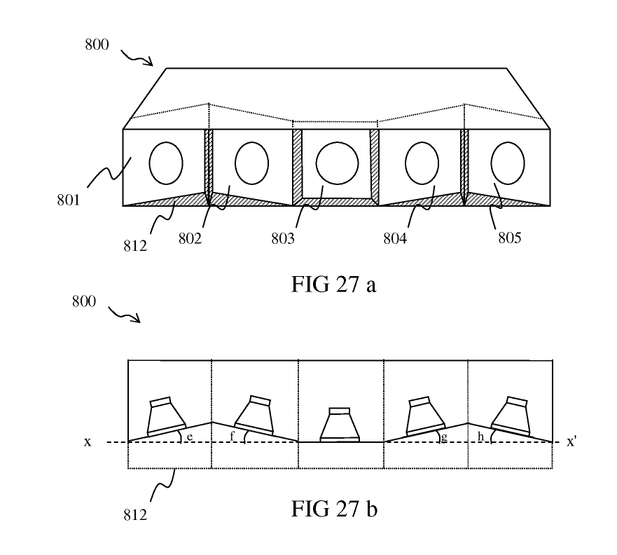

FIG. 27a illustrates an alternate embodiment of the 5.1 channel multidirectional speaker cabinet enclosure according to one embodiment of the invention. In this embodiment, the 5.1 channel multidirectional speaker cabinet enclosure has construction identical to the 5.1 channel multidirectional speaker cabinet enclosure (700) explained with respect to FIG. 25a. In present embodiment, the angle of inclination of the front face of first speaker unit (801) is vertically opposite to the first speaker unit (701, FIG. 25a) which disperses the sound waves to the listeners sitting on the left hand side while facing the multidirectional speaker cabinet enclosure (800) inside a listening area. The angle of inclination of the front face of second speaker unit (802) is vertically opposite to the second speaker unit (702, FIG. 25a) which disperses the sound waves to the listeners sitting on the left hand side while facing the multidirectional speaker cabinet enclosure (800) inside a listening area. The angle of inclination of the front face of fourth speaker unit (804) is vertically opposite to the fourth speaker unit (704, FIG. 25a) which disperses the sound waves to the listeners sitting on the right hand side while facing the multidirectional speaker cabinet enclosure (800) inside a listening area. The angle of inclination of the front face of fifth speaker unit (805) is vertically opposite to the fifth speaker unit (705, FIG. 25a) which disperses the sound waves to the listeners sitting on the left hand side while facing the multidirectional speaker cabinet enclosure (800) inside a listening area.

All the speaker units have a flange (812) around the external edges of the front surface of the speaker units wherein the flange (812) extends at least 2 inches to 4 inches from the front surface whereby directing the sound waves to the direction of inclination of respective front surfaces. Hence this embodiment also provides complete 360 degree listening coverage area using single 5.1 channel multidirectional speaker cabinet enclosure.

FIG. 27b illustrates the orthogonal top view of the 5.1 channel multidirectional speaker cabinet enclosure according to one embodiment of the invention.

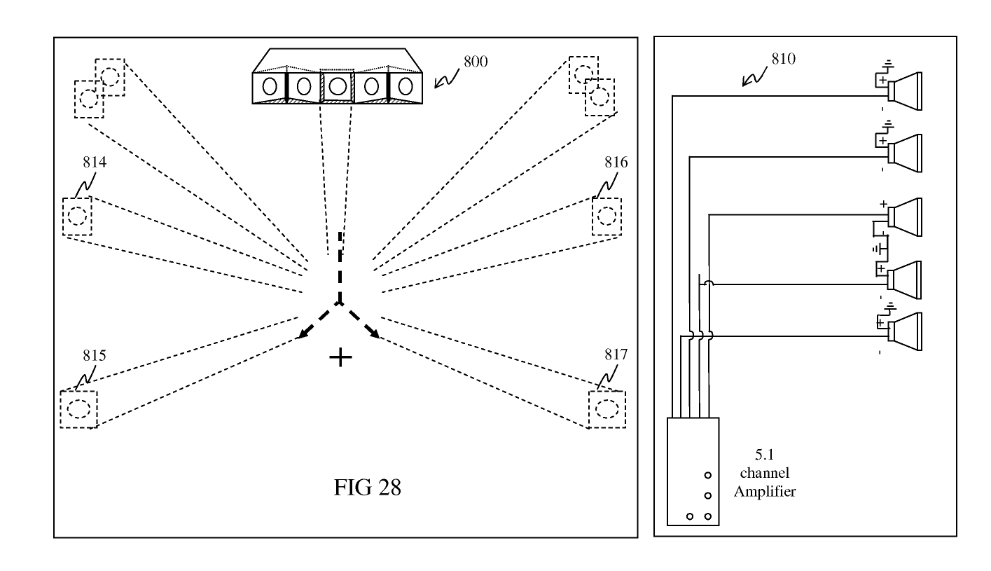

FIG. 28 illustrates the coverage area of the alternate embodiment of the 5.1 channel multidirectional speaker cabinet enclosure with reversed polarities of the speakers in the speaker dividing system. Upon reversing the polarity of the speakers in the speaker units (as shown in the speaker dividing system (810), the output from a normal 5.1 channel AV receiver provides 3 dimensional surround sound effects using 5.1 channel multidirectional speaker cabinet enclosure (800). The 5.1 channel multidirectional speaker cabinet enclosure (800) provides 3 dimensional surround sound effects with virtual left angle coverage (814), virtual right angle coverage (816), virtual rear left angle coverage (815), virtual rear right angle coverage (814) as shown in the figure.

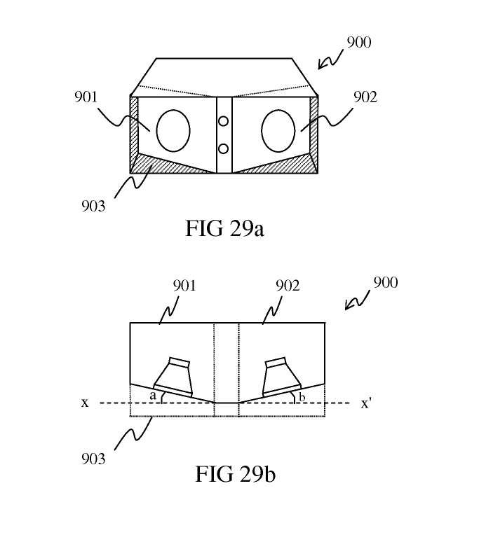

FIG. 29a illustrates the 1.1 multi directional loudspeaker cabinet enclosure according to one embodiment of the invention. In this embodiment, the 1.1 multi directional loudspeaker cabinet enclosure (900) comprises at least one first speaker unit (901) having a sound source mounted on front surface from inside to reproduce sound signals received from a suitable sound source. As shown in the FIG. 29b (orthogonal top view of the 1.1 channel multidirectional speaker cabinet enclosure), the front surface of the first speaker unit (901) is inclined at an angle (∠a) relative to a horizontal axis (x-x′) wherein the front surface is configured to disperse sound waves emanating from the sound source in the direction of inclination. In one embodiment, the angle (∠a) ranges from at least 20 degree to 45 degree which provides a backward inclination to the front surface of first speaker unit (901) to disperse sound waves to the listeners sitting on the right hand side while facing the multidirectional speaker cabinet enclosure (900) inside a listening area.

In one embodiment, the 1.1 multidirectional speaker cabinet enclosure (900) includes at least one second speaker unit (902) coupled to the first speaker unit (901). The second speaker unit (902) includes a sound source mounted on front surface from inside to reproduce sound signals received from a suitable sound source. As shown in the FIG. 25b (orthogonal top view of the 1.1 channel multidirectional speaker cabinet enclosure), the front surface of the second speaker unit (902) is inclined at an angle (∠b) symmetrically opposite to the angle of inclination of the front surface of the first speaker unit (901). In one embodiment, the angle (∠b) of inclination ranges from at least 20 degree to 45 degree which provides an inclination to the front face of second speaker unit (902) in a direction opposite to that of the first speaker unit (901). In exemplary embodiment, the second speaker unit (902) is inclined forward towards the left hand side to disperse sound waves to the listeners sitting on the left hand side while facing the multidirectional speaker (900) inside a listening area.

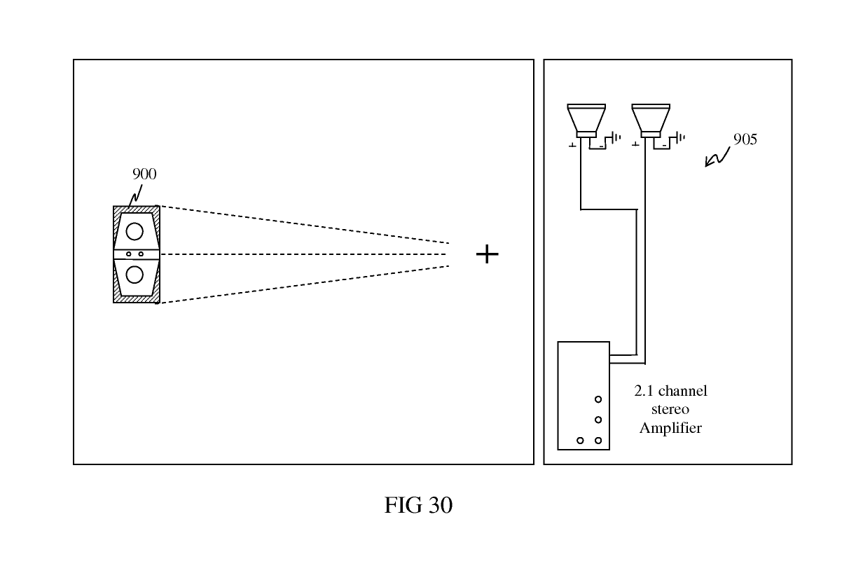

FIG. 30 illustrates the coverage area of the 1.1 channel multidirectional speaker cabinet enclosure receiving stereo channel input from an audio source. In this embodiment, upon receiving input from a speaker dividing system (905) of a normal 1.1 channel AV receiver, the 1.1 channel multidirectional speaker cabinet enclosure (900) covers the central region of the listening area as shown in the figure.

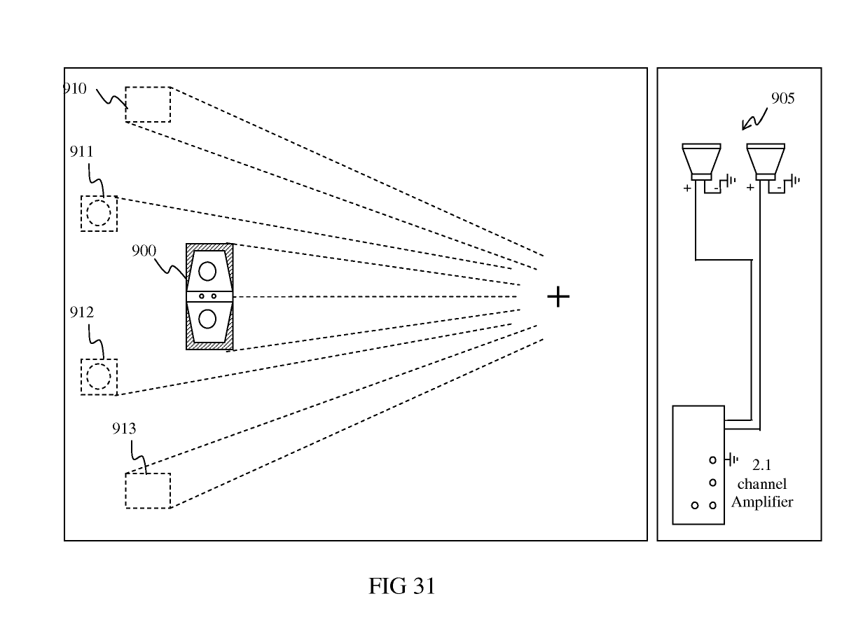

FIG. 31 illustrates the coverage area with virtual sound effect, of the 1.1 channel multidirectional speaker cabinet enclosure receiving 3 dimensional digital surround sound N 360 from an audio source with reversed polarities of the speakers in the speaker dividing system. Upon reversing the polarity of the speakers in the speaker units (as shown in the speaker dividing system (810)), the 1.1 multi directional loudspeaker cabinet enclosure (900) provides 360 degree coverage in an enclosed listening area. The 1.1 multi directional loudspeaker cabinet enclosure (900) provides 3 dimensional digital surround sound effects upon using the 3 dimensional digital surround sound N 360 (patent filed for in India, Application no: 1995/CHE/2011) sound output. The three dimensional effects are as illustrated in the figure with virtual left angle coverage (913), virtual right angle coverage (910), virtual rear left angle coverage (912), virtual rear right angle coverage (911) as shown in the figure.

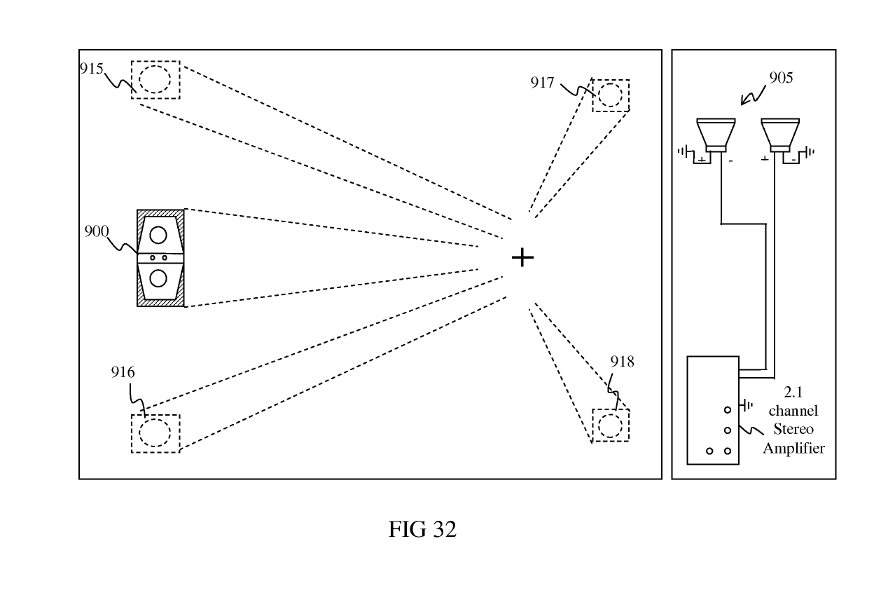

FIG. 32 illustrates the coverage area with virtual sound effect, of the 1.1 channel multidirectional speaker cabinet enclosure receiving 3 dimensional digital surround sound N 360 from an audio source. As shown in the figure, a virtual left angle coverage (916), virtual right angle coverage (915), virtual rear left angle coverage (918), virtual rear right angle coverage (917) as shown in the figure.

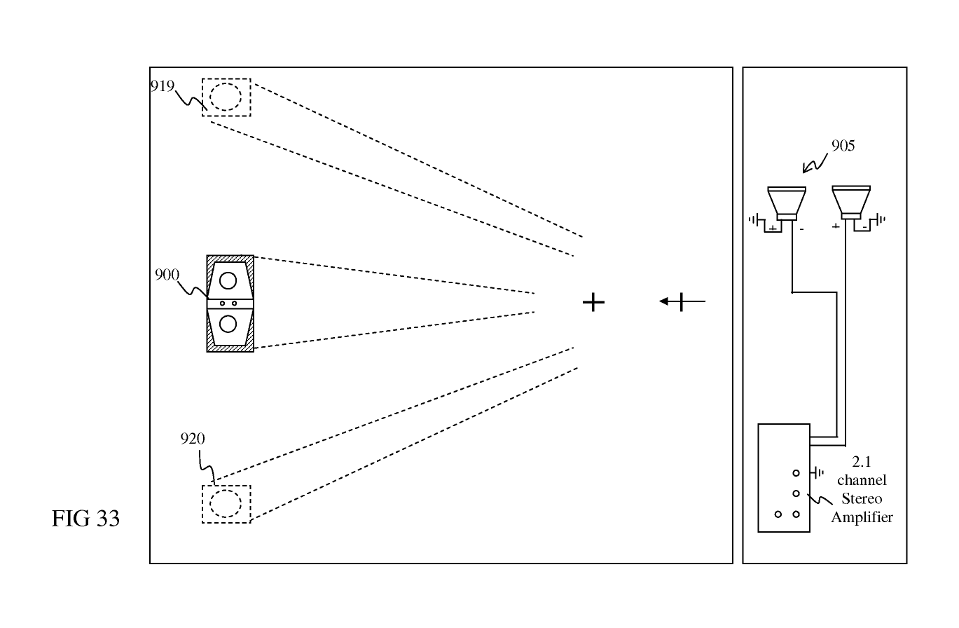

FIG. 33 illustrates the coverage area of the 1.1 channel multidirectional speaker cabinet enclosure receiving stereo channel input from an audio source. Upon reversing the polarity of the speakers in the speaker units (as shown in the speaker dividing system (905), the 1.1 channel multidirectional speaker cabinet enclosure (900) provides a virtual left angle coverage (920) and virtual right angle coverage (919) to the listener virtual rear left angle coverage (918), virtual rear right angle coverage (917) as shown in the figure.

The dimension of each of the loudspeaker cabinet enclosures in various embodiments may vary depending upon the requirements of various listening area such as homes, big or small halls, auditoriums or theatres etc. The loudspeaker cabinet enclosures can be made from rectangular particle-board boxes or may be made of composite materials, internal baffles, ports or acoustic insulation.

With the invented system of loudspeakers, the splitting sound effects produced by the loudspeakers can be experienced uniformly from any location inside the listening area irrespective of the position of the listener.

In some embodiments, each speaker unit may be adjusted separately by using mechanical bearings in order to adjust or alter the angle of inclination of the front surfaces having sound sources depending upon the requirements.

In some embodiments, remote control is affixed to the mechanical bearings with electro-mechanical system wherein the angle of inclination of various loudspeakers can be changed through remote control.

1. A 360 degree angled loudspeaker system comprising:
a. at least one front loudspeaker cabinet enclosure (100) further comprising:
i. at least one top speaker unit (101) disposed at the top of the front loudspeaker cabinet enclosure (100), the top speaker unit (101) having a sound source mounted on front surface from inside to reproduce sound signals received from a suitable sound source wherein the front surface is inclined at a pre determined angle (∠a) relative to a horizontal axis;
ii. at least one middle speaker unit (102) disposed under the top speaker unit (101), the middle speaker unit (102) having a sound source mounted on front surface from inside to reproduce sound signals received from a suitable sound source wherein the front surface is inclined parallel to the horizontal axis (x-x′) to disperse sound waves emanating from the sound source directly reach the listener in a direction perpendicular to the front surface;
iii. at least one bottom speaker unit (103) disposed under the middle speaker unit (102), the bottom speaker unit (103) having a sound source mounted on front surface from inside to reproduce sound signals received from a suitable sound source wherein the front surface is inclined at a predetermined angle (∠b) relative to a horizontal axis (x-x′) wherein the angle (∠b) is symmetrically opposite to the angle (∠b);
iv. a baffle unit (104) positioned under the middle speaker unit (103),
b. at least one centre loudspeaker cabinet enclosure (200) for mounting at the centre of at least two front loudspeaker cabinet enclosures (100), the centre loudspeaker cabinet enclosure (200) further comprising:
i. at least one left speaker unit (201) having a sound source mounted on front surface from inside to reproduce sound signals received from a suitable sound source wherein the front surface is inclined forward at a pre determined angle (∠c) relative to a horizontal axis;
ii. at least one centre speaker unit (202) coupled to the left speaker unit (201), the centre speaker unit (202) having a sound source mounted on front surface from inside to reproduce sound signals received from a suitable sound source wherein the front surface is inclined parallel to the horizontal axis (x-x′) to disperse sound waves emanating from the sound source in direction perpendicular to the front surface;
iii. at least one right speaker unit (203) coupled to the centre speaker unit (202), the right speaker unit (201) having a sound source mounted on front surface from inside to reproduce sound signals received from a suitable sound source wherein the front surface is inclined forward at a pre determined angle (∠d) relative to a horizontal axis, the angle (∠d) is symmetrically opposite to the angle (∠c), the front surface configured to disperse sound waves emanating from the sound source in a direction opposite to that of the left speaker unit (201),
c. at least one rear surround loudspeaker cabinet enclosure (300) for mounting at the rear of the listener to disperse sound from the rear, the rear loudspeaker cabinet enclosure (300) further comprising:
i. at least one left speaker unit (301) having a sound source mounted on front surface from inside to reproduce sound signals received from a suitable sound source wherein the front surface is inclined backwards at a predetermined angle (∠e) relative to a horizontal axis, the front surface is inclined downwards at a predetermined angle (∠f) relative to a vertical axis, the front surface is diagonally inclined downwards at bottom left corner inclined at a angle (∠g) relative to vertical axis (y-y′) wherein the front surface is configured to disperse sound waves emanating from the sound source in the direction of inclination of the front surface;
ii. at least one centre speaker unit (302) coupled to the left speaker unit (301), the centre speaker unit (302) having a sound source mounted on front surface from inside to reproduce sound signals received from a suitable sound source, wherein the front surface of the centre speaker unit (302) is inclined downwards at a predetermined angle (∠h) relative to a vertical axis (y-y′) to disperse sound waves in the direction of inclination of the front surface;
iii. at least one right speaker unit (303) coupled to the centre speaker unit (302), the right speaker unit (301) having a sound source mounted on front surface from inside to reproduce sound signals received from a suitable sound source wherein the front surface is inclined backwards at a predetermined angle (∠i) relative to a horizontal axis, the front surface is inclined downward at a predetermined angle (∠j) relative to a vertical axis, the front surface is diagonally inclined downwards at bottom right corner inclined at an angle (∠k) relative to vertical axis (y-y′) wherein the front surface is configured to disperse sound waves emanating from the sound source in the direction of inclination of the front surface,
wherein the sound waves emanating from the sound sources directly reach the listener present at the direction of inclination of the front surface to provide clear, immersive and 360 degree angle coverage to the listener irrespective of the location of the listener with respect to the sound source by distributing sound waves uniformly across the listening area.

2. The system as claimed in claim 1 wherein all speaker units have a flange around the external edges of the front surface of the speaker units wherein the flange extends at least 2 to 4 inches from the front surface whereby directing the sound waves to the direction of inclination of respective front surfaces.

3. The system as claimed in claim 1 wherein the angle (∠a) of the front surface of the top speaker unit (101) ranges from at least 20 degree to 45 degree to disperse sound waves in direction of inclination.

4. The system as claimed in claim 1 wherein the angle (∠b) of the front surface of the bottom speaker unit (103) ranges from at least 20 degree to 45 degree to disperse the sound waves in a direction opposite to that of the top speaker unit (101).

5. The system as claimed in claim 1 wherein the angle (∠c) of the front surface of the left speaker unit (201) ranges from at least 5 degree to 30 degree to disperse sound waves in direction of inclination.

6. The system as claimed in claim 1 wherein the angle (∠d) of the front surface of the right speaker unit (203) ranges from 5 degree to 30 degree to disperse the sound waves in a direction opposite to that of the left speaker unit (201).

7. The system as claimed in claim 1 wherein the angle (∠e) of the front surface of the left speaker unit (301) ranges from at least 5 degree to 30 degree to disperse sound waves in the direction of inclination.

8. The system as claimed in claim 1 wherein the angle (∠f) of the front surface of the left speaker unit (301) ranges from 5 degree to 60 degree to disperse sound waves in the direction of inclination.

9. The system as claimed in claim 1 wherein the angle (∠g) of the front surface of the left speaker unit (301) ranges from 10 degree to 60 degree to disperse sound waves in the direction of inclination.

10. The system as claimed in claim 1 wherein the angle (∠h) of the front surface of the centre speaker unit (302) ranges from 5 degree to 60 degree to disperse sound waves in the direction of inclination.

11. The system as claimed in claim 1 wherein the angle (∠i) of the front surface of the right speaker unit (303) ranges from at least 5 degree to 30 degree to disperse sound waves in the direction of inclination.

12. The system as claimed in claim 1 wherein the angle (∠j) of the front surface of the right speaker unit (303) ranges from 5 degree to 60 degree to disperse sound waves in the direction of inclination.

13. The system as claimed in claim 1 wherein the angle (∠k) of the front surface of the right speaker unit (303) ranges from 10 degree to 60 degree to disperse sound waves in the direction of inclination.

14. A 360 degree multi speaker sound system for use in large listening areas, the system comprising:
a. at least one front multi speaker cabinet enclosure (600a) for mounting at the front side, facing the audience in a large listening area, the front multi speaker cabinet enclosure (600a) further comprising:
i. at least one speaker unit (601a) further comprising:
at least one left speaker unit (604) having a sound source mounted on front surface from inside to reproduce sound signals received from a suitable sound source wherein the front surface is inclined at a predetermined angle (∠a) relative to a horizontal axis (x-x′), the front surface configured to disperse sound waves emanating from the sound source in the direction of inclination of front surface;
at least one right speaker unit (605) coupled to the left speaker unit (604), the right speaker unit (605) having a sound source mounted on front surface from inside to reproduce sound signals received from a suitable sound source wherein the front surface is inclined parallel to the horizontal axis (x-x′) to disperse sound waves in direction perpendicular to the front surface;
ii. a baffle unit (601d),
b. at least one centre multi speaker cabinet enclosure (400) for mounting at the centre of at least two front multi speaker cabinet enclosures (600), the centre multi speaker cabinet enclosure (400) further comprising:
i. at least one top speaker unit (400a) further comprising:
at least one left speaker unit (401) having a sound source mounted on front surface from inside to reproduce sound signals received from a suitable sound source;
at least one centre speaker unit (402) coupled to the left speaker unit (401), the centre speaker unit (402) having a sound source mounted on front surface from inside to reproduce sound signals received from a suitable sound source;
at least one right speaker unit (403) coupled to the centre speaker unit (402), the right speaker unit (401) having a sound source mounted on front surface from inside to reproduce sound signals received from a suitable sound source,
wherein the front surfaces of the left speaker unit (401), centre speaker unit (402) and right speaker unit (403) are inclined parallel to the horizontal axis (x-x′) to disperse sound waves in a direction perpendicular to the front surface,
ii. at least one middle speaker unit (400b) coupled to the top speaker unit (400a), the middle speaker unit (400b) further comprising:
at least one left speaker unit (404) having a sound source mounted on front surface from inside to reproduce sound signals received from a suitable sound source wherein the front surface is diagonally inclined downwards at bottom right corner at a angle (∠b) relative to vertical axis (y-y′) wherein the front surface is configured to disperse sound waves emanating from the sound source in the direction of inclination of front surface;
at least one centre speaker unit (405) coupled to the left speaker unit (404), the centre speaker unit (405) having a sound source mounted on front surface from inside to reproduce sound signals received from a suitable sound source wherein the front surface is inclined downwards at a predetermined angle (∠c) relative to a vertical axis (y-y′) wherein the front surface is configured to disperse sound waves emanating from the sound source in the direction of inclination of front surface;
at least one right speaker unit (406) coupled to the centre speaker unit (405), the right speaker unit (406) having a sound source mounted on front surface from inside to reproduce sound signals received from a suitable sound source wherein the front surface is diagonally inclined downwards at bottom left corner inclined at a angle (∠d) relative to vertical axis (y-y′) wherein the front surface is configured to disperse sound waves emanating from the sound source in the direction of inclination of front surface,
iii. at least one bottom speaker unit (400c) coupled to the middle speaker unit (400b), the bottom speaker unit (400c) further comprising:
at least one left speaker unit (407) having a sound source mounted on front surface from inside to reproduce sound signals received from a suitable sound source wherein the front surface is diagonally inclined downwards at bottom right corner inclined at an angle (∠e) relative to vertical axis (y-y′) wherein the front surface is configured to disperse sound waves emanating from the sound source in the direction of inclination of front surface;
at least one centre speaker unit (408) coupled to the left speaker unit (407), the centre speaker unit (408) having a sound source mounted on front surface from inside to reproduce sound signals received from a suitable sound source wherein the front surface is inclined downwards at a predetermined angle (∠f) relative to a vertical axis (y-y′) wherein the front surface is configured to disperse sound waves emanating from the sound source in the direction of inclination of the front surface;
at least one right speaker unit (409) coupled to the centre speaker unit (408), the right speaker unit (409) having a sound source mounted on front surface from inside to reproduce sound signals received from a suitable sound source wherein the front surface is diagonally inclined downwards at bottom left corner inclined at an angle (∠g) relative to vertical axis (y-y′) wherein the front surface is configured to disperse sound waves emanating from the sound source in the direction of inclination of the front surface,
iv. at least one baffle unit (400d),
c. at least one rear multi speaker cabinet enclosure (500) mounted at the rear of the audience in a large listening area, the rear multi speaker cabinet enclosure (500) further comprising:
i. at least one top speaker unit (500a) further comprising:
at least one top left speaker unit (501) having a sound source mounted on front surface from inside to reproduce sound signals received from a suitable sound source wherein the front surface of the top left speaker unit (501) is inclined at an angle (∠h) relative to a horizontal axis (x-x′), the front surface inclined at an angle (∠i) relative to a vertical axis (y-y′), the front surface is diagonally inclined inward at top left corner inclined at an angle (∠j) relative to vertical axis (y-y′) wherein the front surface configured to disperse sound waves emanating from the sound source in the direction of inclination;
at least one top centre speaker unit (502) coupled to the top left speaker unit (501), the top centre speaker unit (502) having a sound source mounted on front surface from inside to reproduce sound signals received from a suitable sound source, the front surface of the top centre speaker unit (502) is inclined inward at an angle (∠k) relative to vertical axis (y-y′) wherein the front surface is configured to disperse sound waves emanating from the sound source in the direction of inclination of the front surface;
at least one top right speaker unit (503) coupled to the top centre speaker unit (502), the top right speaker unit (503) having a sound source mounted on front surface from inside to reproduce sound signals received from a suitable sound source wherein the front surface of the top right speaker unit (503) is inclined at an angle (∠l) relative to a horizontal axis (x-x′), the front surface inclined at a angle (∠m) relative to a vertical axis (y-y′), the front surface is diagonally inclined inward at top right corner inclined at a angle (∠n) relative to vertical axis (y-y′) wherein the front surface configured to disperse sound waves emanating from the sound source in the direction of inclination of the front surface,
ii. at least one bottom speaker unit (500b) disposed below top speaker unit (500a), the bottom speaker unit (500b) further comprising:
at least one bottom left speaker unit (504) coupled to the bottom speaker unit (500b) wherein the angle of inclination of the front surface of the bottom left speaker unit (504) is vertically opposite to the angle of inclination of the front surface of the top left speaker unit (501);
at least one bottom centre speaker unit (505) coupled to the bottom left speaker unit (504) wherein the angle of inclination of the front surface of the bottom centre speaker unit (505) is vertically opposite to the angle of inclination of the front surface of the top centre speaker unit (502);
at least one bottom right speaker unit (506) coupled to the bottom speaker unit (500b) wherein the angle of inclination of the front surface of the bottom right speaker unit (506) is vertically opposite to the angle of inclination of the front surface of the top right speaker unit (503),
iii. at least one baffle unit (600d),
wherein the sound waves emanating from the sound sources directly reach the listener present at the direction of inclination of the front surface to provide clear, immersive and 360 degree angle coverage to the listener irrespective of the location of the listener with respect to the sound source by distributing sound waves uniformly across the listening area.

15. The 360 degree multi speaker sound system as claimed in claim 14 wherein all speaker units have a flange around the external edges of the front surface of the speaker units wherein the flange extends at least 2 inches to 4 inches from the front surface whereby directing the sound waves to the direction of inclination of respective front surfaces.

16. The 360 degree multi speaker sound system as claimed in claim 14 wherein the angle (∠a) ranges from at least 20 degree to 45 degree.

17. The 360 degree multi speaker sound system as claimed in claim 14 wherein the angle (∠b) ranges from at least 10 degree to 60 degree.

18. The 360 degree multi speaker sound system as claimed in claim 14 wherein the angle (∠c) ranges from at least 5 degree to 60 degree.

19. The 360 degree multi speaker sound system as claimed in claim 14 wherein the angle (∠d) ranges from at least 10 degree to 60 degree.

20. The 360 degree multi speaker sound system as claimed in claim 14 wherein the angle (∠e) ranges from at least 5 degree to 70 degree.

21. The 360 degree multi speaker sound system as claimed in claim 14 wherein the angle (∠f) ranges from at least 5 degree to 70 degree.

22. The 360 degree multi speaker sound system as claimed in claim 14 wherein the angle (∠g) ranges from at least 10 degree to 70 degree.

23. The 360 degree multi speaker sound system as claimed in claim 14 wherein the angle (∠h) ranges from at least 5 degree to 30 degree.

24. The 360 degree multi speaker sound system as claimed in claim 14 wherein the angle (∠i) ranges from at least 5 degree to 60 degree.

25. The 360 degree multi speaker sound system as claimed in claim 14 wherein the angle (∠j) ranges from at least 10 degree to 60 degree.

26. The 360 degree multi speaker sound system as claimed in claim 14 wherein the angle (∠k) ranges from at least 5 degree to 70 degree.

27. The 360 degree multi speaker sound system as claimed in claim 14 wherein the angle (∠l) ranges from at least 5 degree to 30 degree.

28. The 360 degree multi speaker sound system as claimed in claim 14 wherein the angle (∠m) ranges from at least 5 degree to 60 degree.

29. The 360 degree multi speaker sound system as claimed in claim 14 wherein the angle (∠n) ranges from at least 10 degree to 60 degree.

30. A multidirectional speaker cabinet enclosure (700) providing at least 2.1 channel sound effects, the multidirectional speaker (700) comprising:
a. at least one first speaker unit (701) having a sound source mounted on front surface from inside to reproduce sound signals received from a suitable sound source wherein the front surface of the first speaker unit (701) is inclined at an angle (∠a) relative to a horizontal axis (x-x′) wherein the front surface is configured to disperse sound waves emanating from the sound source in the direction of inclination of the front surface;
b. at least one second speaker unit (702) coupled to first speaker unit (701), the second speaker unit (702) having a sound source mounted on front surface from inside to reproduce sound signals received from a suitable sound source wherein the front surface of the second speaker unit (702) is inclined at an angle symmetrically opposite to the angle of inclination of the front surface of the first speaker unit (701) wherein the front surface is configured to disperse sound waves emanating from the sound source in the direction opposite to the direction sound dispersed through first speaker unit (701);
c. at least one third speaker unit (703) having a sound source mounted on front surface from inside to reproduce sound signals received from a suitable sound source wherein the front surface is inclined parallel to a horizontal axis (x-x′) to disperse sound waves in a direction perpendicular to the front surface,
wherein the sound waves emanating from the sound sources directly reach the listener present at the direction of inclination of the front surface to provide clear, immersive and 360 degree angle coverage to the listener irrespective of the location of the listener with respect to the sound source by distributing sound waves uniformly across the listening area.

31. The multidirectional speaker cabinet enclosure as claimed in claim 30 wherein all the speaker units have a flange (712) around the external edges of the front surface of the speaker units wherein the flange (712) extends at least 2 inches to 4 inches from the front surface whereby directing the sound waves to the direction of inclination of respective front surfaces.

32. 2] The multidirectional speaker cabinet enclosure as claimed in claim 30 wherein the angle (∠a) ranges from at least 20 degree to 45 degree.
